(19) United States
(12) Patent Application Publication
(10) Pub. No.: US 2011/0055722 A1
(43) Pub. Date: Mar. 3, 2011

(54) Data Visualization Environment with DataFlow Processing, Web, Collaboration, Advanced User Interfaces, and Spreadsheet Visualization

(76) Inventor: Lester F. LUDWIG, Belomont, CA (US)

(21) Appl. No.: 12/875,119

(22) Filed: Sep. 2, 2010

Related U.S. Application Data
(60) Provisional application No. 61/239,426, filed on Sep. 2, 2009.

(51) Int. Cl. G06F 3/00; G06F 3/048

(52) U.S. Cl. 715/751; 715/809

(57) ABSTRACT

A method for interactive data visualization to perform data analysis comprising dataflow processing of information and utilizing mathematical operations designed to accept, operate on, and produce numerical data within the universal range of numbers such as the interval [0,1] or [−1,+1]. In an implementation, visual effects responsive to data values and interactive control produces computer graphics instructions that can be rendered as graphics in a browser and transmitted over a network. Interactive control can also be transmitted over a network so as to provide web access and a collaboration environment. In an implementation the selection of function blocks and the general connectivity among them can be specified by using a drawing tool and a palette of function blocks, and clicking on each function block would cause dialog windows to appear that can be used for setting parameters.

### CROSS-REFERENCE TO RELATED APPLICATIONS

This application claims benefit of priority of U.S. provisional application Ser. No. 61/239,426 filed on Sep. 2, 2009, incorporated herein by reference.

### BACKGROUND OF THE INVENTION

1. Field of the Invention

The invention relates to data visualization and in particular to creating an interactive data visualization environment for data analysis comprising dataflow processing of information from stored and live data sources, web access, collaboration capabilities, incorporation of high-dimensional user interface devices (such as HDTP and advanced mice), spreadsheet visualization, and data sonification capabilities.

2. Background of the Invention

The present invention provides several useful data visualization capabilities to traditional data visualization environments. The invention is directed to creating a data visualization environment comprising one or more of:
Dataflow processing;
Operations on information from stored and live data sources;
Web access capabilities;
Collaboration capabilities;
Support for and incorporation of high-dimensional user interface devices such as
   High-Dimensional Touch Pad and touch screen (HDTP) technologies as taught in U.S. Pat. No. 6,570,078 and pending U.S. patent application Ser. Nos. 11/761,978 and 12/418,605;
   Advanced mouse technologies as taught in U.S. Pat. No. 7,557,797;
Support for and incorporation of spreadsheet visualization as taught in pending U.S. Patent Application 61/239,349;
Support for and incorporation of data sonification capabilities as taught in pending U.S. patent application Ser. No. 12/817,196.

The visual effects provided for by the invention can be automatically varied over a range responsive to values of data or formulas according to mathematical functions, compositions of mathematical functions, or traditional spreadsheet formulas to easily provide rich detailed control of useful parameterized visual effects rendered in the context of conventional data visualizations, maps, spreadsheets, and tabular data displays. (In this document, the term “spreadsheet” will be understood to mean interactive electronic spreadsheet programs.)

The visual effects can include variation of background color or texture or border color, thickness, grouping scope of cells enveloping characters conveying data, as well as font color, type, embellishment, size, format, location, decimal places, or supplemental symbols symbolic or image element rendered within the cell of characters conveying data. Additionally, the invention provides for data-driven 3D plots rendered in the context of or projection from interactive electronic spreadsheet or tabular data. The invention provides for these visualization operations to be generated by an algorithm directly or indirectly in communication with data or parts of a program rendering an interactive electronic spreadsheet or visually displayed data table. The invention also provides for various optional additional functions, for example:
Data-driven automatic “live” sorting of rows and columns;
Incorporation of externally-provided stored data and live data feeds;
Real-time response to live input data, interactive data entry, or visualization manipulation via interactive user interfaces;
Collaboration capabilities;
Web-access capabilities;
Meaningful data sonification capabilities, including those involving multichannel timbre modulation.

### SUMMARY OF THE INVENTION

The invention relates to data visualization and in particular to creating an interactive data visualization environment for data analysis comprising dataflow processing of information from stored and live data sources, comprising one or more of web access capabilities, collaboration capabilities, incorporation of high-dimensional user interface devices (such as HDTP and advanced mice), spreadsheet visualization, and data sonification capabilities.

In an aspect of the invention an interactive data visualization environment for data analysis comprised dataflow processing of information and interactive data visualization under the control of high-dimensional user interface devices such as HDTP and advanced mice,

In another aspect of the invention, the system provides real-time response to visualization manipulation via interactive user interfaces.

In another aspect of the invention an interactive data visualization environment for data analysis comprising dataflow processing of information further comprises interactive data sonification,

In another aspect of the invention, the system provides collaboration capabilities.

In another aspect of the invention, the system provides web-access capabilities.

In another aspect of the invention a presentation attribute provided a pre-defined range of variability and is controlled by a parameter that can vary over a pre-defined range (for example, between 0 and 1, between 0 and 100, between −1 and +1, etc).

In another aspect of the invention this parameter-controlled variability of a data or cell presentation attribute allows that presentation attribute to be used as a visualization parameter.

In another aspect of the invention the value of a data element is used to determine the color of a font.

In another aspect of the invention the value of a data element is used to determine the selection of a font.

In another aspect of the invention the value of a data element is used to determine the embellishment of a font.

In another aspect of the invention the value of a data element is used to determine the size of a font.

In another aspect of the invention the value of a data element is used to determine the addition of an appending symbol.

In another aspect of the invention the value of a data element is used to determine the number of decimal places.

In another aspect of the invention the value of a data element is used to determine a method of numerical rounding.

In another aspect of the invention the value of a data element is used to determine a degree of numerical rounding.

In another aspect of the invention the value of a data element is used to determine the format used to render some data element within the visualization.

In another aspect of the invention the value of a data element is used to determine the selection of a symbolic data element rendered within the visualization.

In another aspect of the invention the value of a data element is used to determine the selection of an image element rendered within the visualization.

In another aspect of the invention an interactive data visualization environment for data analysis comprising dataflow processing of information further comprises interactive spreadsheet visualization,

In another aspect of the invention, visualization operations are generated by an algorithm in communication with a program rendering the spreadsheet or data table.

In another aspect of the invention, visualization operations are generated by an algorithm in communication with the data stored in rendering the spreadsheet or data table.

In another aspect of the invention, visualization operations are generated by an algorithm in communication within a program rendering the spreadsheet or data table.

In another aspect of the invention, the system provides data-driven automatic “live” sorting of rows and columns.

In another aspect of the invention, the data used includes externally-provided stored data. In another aspect of the invention, the data used includes externally-provided live data feeds.

In another aspect of the invention, the system provides real-time response to interactive data entry. In another aspect of the invention, the system provides real-time response to live input data.

In another aspect of the invention, the system provides one or more user interfaces compositely providing one or more of the following capabilities:

Setup of a fixed data analysis configuration;

Setup of fixed data visualization configuration;

Setup of fixed data visualization presentation;

Setup of an interactive data analysis configuration;

Setup of an interactive data analysis session;

Setup of an interactive data visualization configuration;

Setup of an interactive visualization session;

Interactive control of data source selection and usage;

Interactive control of data analysis sessions;

Interactive control of visualization sessions;

Storage and recall of configurations;

Storage and recall of data;

Storage and recall of visualizations;

Storage and recall of sessions.

In another aspect of the invention, the system includes at least one user interface that provides for the selection of function blocks and the general connectivity among them to be specified using a drawing tool and a palette of function blocks.

In another aspect of the invention, clicking on each function blocks afore described would cause dialog windows to appear that can be used for setting parameters. The parameters can be set by means of typed-in values, sliders, mouse manipulation, or the advanced high-dimension user interface devices.

Another aspect of the invention provides a method for interactive data visualization to perform data analysis comprised dataflow processing of information and interactive data visualization, the method comprising:
Specifying a data source to provide data to be analysis;
Specifying a plurality of mathematical operations to be performed on the data to be provided by the data source, wherein:
   each of the plurality of mathematical operations designed to accept, operate on, and produce numerical data within the universal range of numbers; and
   at least one of the mathematical operations comprises a mathematical function that can be numerically calculated;
Specifying an interconnection among the plurality of mathematical operations so as to determine paths of dataflow among the plurality of mathematical operations;
Specifying at least one initial value of a function parameter to at least one of the plurality of mathematical operations, the mathematical operation responsive to the value of the function parameter;
Obtaining at least one collection of data from the data source, the collection of data comprising at least an array of data values;
Using at least one of the plurality of mathematical operations to compute at least one visual parameter responsive to at least one data value from the collection of data and responsive to the function parameter, wherein each visual parameter is a number within the universal range of numbers, and wherein said number is determined according to a numerically calculated mathematical function;
Controlling a visual effect of the at least one data value according to the at least one visual parameter;
Creating responsively-generated computer graphics instructions;
Rendering the visual effect from the computer graphics instructions to produce computer-produced graphical output representing at least one aspect of the collection of data.

### BRIEF DESCRIPTION OF THE DRAWINGS

The above and other aspects, features and advantages of the present invention will become more apparent upon consideration of the following description of embodiments taken in conjunction with the accompanying drawing figures. The accompanying figures are examples of the various aspects and features of the present invention and are not limiting either individually or in combination.

FIG. 1 illustrates an arrangement of selected more general aspects of the invention that are not restricted to spreadsheet visualization.

FIG. 2 illustrates an adaptation of the arrangement of FIG. 1 to an environment supporting collaboration features.

FIG. 3 depicts a topological interconnection of data flow paths linking various elements depicted in FIG. 1.

FIGS. 4a-4c depict approaches for mapping a data value lying within a pre-defined range to a value within a pre-defined range for a parameterized data or cell presentation attribute.

FIG. 5 depicts a more general view and organization of pre-visualization operations provided for by the invention.

FIG. 6 depicts an embodiment wherein a selected metaphor is used to automatically generate parameter assignments and graphics rendering operations.

FIGS. 7a-7g depict transformations of graphics objects via array operations as provided for by the invention.

FIG. 8 provides a demography of ways in which data visualization and spreadsheets can be integrated together.

FIG. 9 depicts of data and cell presentation attributes serving as candidates for visualization parameters within a spreadsheet display.

FIG. 10 depicts a spreadsheet architecture and information flow as it might be used in a data visualization setting.

FIGS. 11a-11d depict various types of architectural approaches for combining and integrating spreadsheet programs, visualization operations provided by the invention, and a data set used by each.

FIG. 12 depicts a visualization wherein an attribute of a column area of data elements is varied as a group.

FIG. 13 depicts a visualization wherein the shading of a of a row area of data elements is varied as a group as a function of a data value and also wherein the font boldness of a column area of data elements is varied as a group as a function of another data value.

FIG. 14 illustrates a priority job queue model tabular-data visualization wherein the row can automatically reorder among themselves as underlying priority vales change.

FIG. 15 depicts a 2D-surface representing a 3D data plot of at least 3-dimensional data rendered above a planar array of associated tabular data or spreadsheet, these separated by a vertical gap within a 3D visual field as provided for by the invention.

FIG. 16 depicts with dashed lines a few ways in which the observation viewpoint can be moved with respect to these abstract objects.

FIG. 17 depicts a translation and rotation of a 3D data plot within the 3D visual field.

FIG. 18a depicts an arrangement wherein data plotted in a 2D-surface representing a 3D data plot within the 3D visual field can directly echo data displayed in a planar array of associated tabular data or spreadsheet or can originate from another set of tabular data or spreadsheet region or from other data.

FIG. 18b depicts an arrangement wherein processing of data via mathematical transformations, statistical processing, signal processing, etc. is made prior to creation of the 2D-surface representing at least 3-dimensional data.

FIG. 19 illustrates a height measuring visual in its use with 2D-surface representing at least 3-dimensional data and useful for representing at least 4-dimensional data.

FIG. 20 depicts augmentation of a spreadsheet program with additional spreadsheet features as provided for by the invention.

FIGS. 21a-21b depict ways in which one or more user interface input devices (such as a mouse, trackball, touchpad, etc.) can be managed so as to control graphical user interfaces of a plural software application in the context of the invention.

FIGS. 22a-22f illustrate the six independently adjustable degrees of freedom of touch from a single finger that can be simultaneously measured by the HDTP technology.

FIG. 23 suggests general ways in which two or more of these independently adjustable degrees of freedom can be adjusted at once.

FIG. 24 demonstrates a few two-finger multi-touch postures and gestures from the many that can be readily recognized by HTDP technology.

FIG. 25 shows how raw measurements of the six quantities of FIGS. 22a-22f, together with shape recognition for distinguishing contact with various parts of the hand and the touchpad, can be used to create a rich information flux of parameters, rates, and symbols.

FIG. 26 shows an approach for incorporating posture recognition, gesture recognition, state machines, and parsers to create an even richer human/machine tactile interface system capable of incorporating syntax and grammars.

FIG. 27 depicts a user interface input arrangement incorporating one or more HDTPs that provide user interface input event and quantity routing of the type described earlier in conjunction with FIGS. 16a-16b.

FIGS. 28a-28L depict a number of arrangements employing the HDTP technology suitable for use with visualization environments.

FIGS. 29a-29b illustrate examples of scroll-wheel mice provided with an additional scroll-wheel.

FIGS. 30a-30c illustrate a single trackball incorporated into the back of a conventional computer mouse.

FIGS. 31a-31c illustrate two trackballs incorporated into the back of a conventional computer mouse.

FIG. 32 depicts an arrangement wherein the HDTP or alternatives such as advanced mice can interface with browser-based applications via a browser plug-in.

FIG. 33 depicts an implementation for rendering visualization in a browser.

FIG. 34 depicts a web-based implementation of a visualization environment leveraging browser arrangements such as that depicted in FIGS. 32-33, their variations, alternatives, etc.

FIGS. 35a-35c depict methods for interfacing a high-dimension user interface device such as a HDTP or Advanced Mouse with a browser.

FIG. 36a depicts a client-side collaboration implementation wherein a general purpose collaboration tool can be used to share the visualization environment session running on one computer with one or more other computers.

FIG. 36b depicts a server-side collaboration implementation wherein a general purpose or specialized server-side application sharing environment is used to share a server-based interactive data visualization application.

FIG. 36c depicts a server-side collaboration implementation comprising a server-based multi-user interactive data visualization application.

FIG. 37 illustrates a general framework for data sonification wherein a parameterized metaphor is used to manage parameter assignment and sound rendering and a parameterized data indexing operation.

FIG. 38 depicts an arrangement wherein the hue of a color can be varied through natural colors of red through violet for the bulk of the [0,1] range and a range of artificial colors, such as the purple through magenta continuum, are appended for the remaining portion of the [0,1] range.

FIG. 39 illustrates an arrangement wherein line width, line dashing period, line dashing duty-cycle, and line dashing sub-duty-cycle can be determined by a uniform parameter in the range of [0,1].

FIG. 40 illustrates an arrangement wherein stipple line width, stipple gap, and stipple angle can be determined by a uniform parameter in the range of [0,1].

FIG. 41 depicts an attribute control panel wherein there are pre-selected values and a value which can be customized.

FIG. 42 depicts an arrangement wherein a change in color of a font can be specified for a cell, a group of cells, or globally across an entire worksheet.

FIG. 43 depicts an interface that determines a font type of the specified cell(s).

FIG. 44 depicts an interface that determines the embellishment of a font in rendering some data element within the spreadsheet or data table.

FIG. 45 depicts an interface to control the size of a font to be displayed.

FIG. 46 depicts an interface that can be used to specify the background texture or stipples to be applied to a cell or a group of cells.

FIG. 47 depicts an interface that can be used to specify the position of text being displayed in a cell.

FIG. 48 depicts an interface that can be used to specify the rotation of text being displayed combined with the vertical or horizontal placement of the text.

FIG. 49a illustrates a basic map-based visualization example generated from previous data.

FIG. 49b shows the map-based visualization of FIG. 49a augmented with additional spatially located symbols or parameterized glyphs.

FIG. 50 depicts a slicing function here used to provide a (planar-slice) level set curve.

FIG. 51a illustrates two 2D-surfaces, each representing at least 3-dimensional data.

FIG. 51b illustrates the interactively created intersection of the two 2D-surfaces and the resultant intersection curve.

FIG. 52 depicts an arrangement wherein a curve can be generated by tabular data and be suspended over tabular data used to create it or otherwise associated with the curve, and can be visually linked to a geometric rendering of tabular data values.

FIG. 53 depicts an arrangement wherein a curve can be given a thickness and or color under the control of data values.

FIG. 54 depicts an arrangement wherein the thickness of a curve can be varied as a function of one or more data values.

FIG. 55 depicts a curve intersection tool that can be used as a numerical solution operator for plotted, interpolated, and processed data.

### DETAILED DESCRIPTION

In the following description, reference is made to the accompanying drawing figures which form a part hereof, and which show by way of illustration specific embodiments of the invention. It is to be understood by those of ordinary skill in this technological field that other embodiments can be utilized, and structural, electrical, as well as procedural changes can be made without departing from the scope of the present invention. The aspects and features described herein may be used singly or in combination unless specifically stated otherwise.

Many features of the invention can be implemented with simple vector graphics rendering operations or easily managed mixtures of vector and raster graphics, permitting:
Implementation employing well-established graphics utilities such as SVG (http://www.w3.org/TR/SVG11/) and the graphics utilities of various computer operating systems provided by companies such as Microsoft and Apple;
Via these and other graphics utilities, implementation of most of the invention's presentation features in browser-rendered web applications, thus making the invention's presentation features available in a web page;
Via web and other implementation approaches, implementation of the invention's presentation features in a collaborative viewing environment.

Additionally, the invention provides for the control of data and cell presentation attributes through use of a uniform parameterization framework. This allows pre-visualization operations, such as scaling, translation, filtering, array (matrix, tensor) operations, nonlinear warping, etc. to be employed in a modular, cascadable fashion independent of the particular choice of data and cell presentation attributes. The invention further provides for pre-visualization operations to themselves have parameters that can be adjusted in real time or be stored in files for recall. The invention further provides for a network of pre-visualization operations to be stored in files for recall.

The invention additionally provides for advanced user interface devices, particularly those providing large numbers of simultaneously-adjustable interactive control parameters, to be used to control the viewing, presentation, and creation of the visualization as well as controlling the underlying data source such as databases, statistical packages, simulations, etc.

Further, via web and other implementation approaches, the implementation of the invention's presentation features in a collaborative interactive use environment.

The present invention provides for:
the use of arbitrary or integrated data sources (such as static databases, dynamic databases, streaming databases, live sensing data streams, numerical simulations, signal processing, statistical processing, linear and nonlinear transformations, etc.);
uniform parameterizations of selected or all visualization presentation parameters;
the support for real-time updates to integrated data sources (such as static databases, dynamic databases, streaming databases, live sensing data streams, numerical simulations, signal processing, statistical processing, linear and nonlinear transformations, etc.);
the use of data flow paths to link arbitrary data sources with arbitrary data destinations via arbitrary topologies (graphically, via an interconnection, specification, or data-flow language, etc.);
the providing of shared GUI environments for controlling two or more of visualization rendering, pre-visualization operations, and data sources.

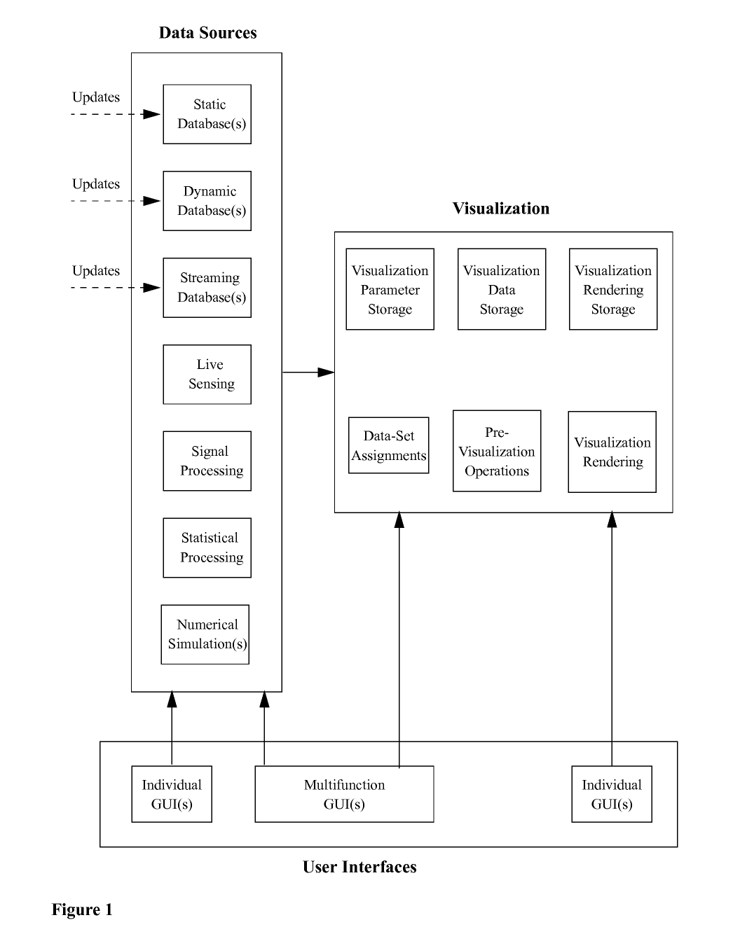

FIG. 1 illustrates an arrangement of these more general aspects of the invention. Implicit in FIG. 1 are more general aspects of the invention, that support visual rendering in a browser window and as a web application. As shown in the figure, graphical user interfaces (GUIs) are provided for including one or more relating to data sources and one or more relating to visualization processes. Additionally, the invention also provides for multifunction GUIs that provide roles involving both data source matters and visualization processes. The overall collection of user interfaces provides the following capabilities:

Setup of a fixed data analysis configuration;

Setup of fixed data visualization configuration;

Setup of fixed data visualization presentation;

Setup of an interactive data analysis configuration;

Setup of an interactive data analysis session;

Setup of an interactive data visualization configuration;

Setup of an interactive visualization session;

Interactive control of data source selection and usage;

Interactive control of data analysis sessions;

Interactive control of visualization sessions;

Storage and recall of configurations;

Storage and recall of data;

Storage and recall of visualizations;

Storage and recall of sessions.

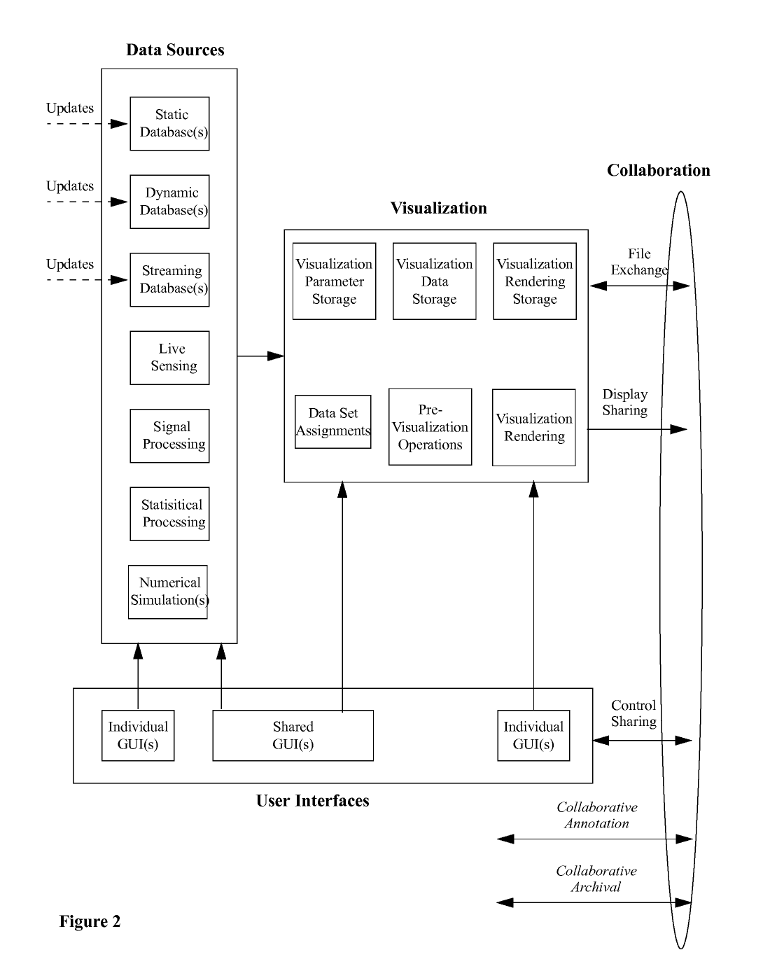

Yet additional aspects of the invention include (real-time and non-real-time) collaboration capabilities. FIG. 2 illustrates an adaptation of the arrangement of FIG. 1 to a collaboration environment supporting collaboration features such as one or more of file exchange, real-time or stored display sharing, real-time control sharing, real-time or stored collaborative annotation, and archives of collaboration sessions and transactions.

### Uniform Parameterizations of Cell and Data Presentation Attributes

The invention provides for uniform parameterizations of selected or all visualization presentation parameters. This allows pre-visualization operations, such as scaling, translation, filtering, array (matrix, tensor) operations, nonlinear warping, etc. to be employed in a modular, cascadable fashion.

### Data Flow Paths to Implement Arbitrary Interconnection Topologies

The invention provides for the use of data flow paths to link arbitrary data sources with arbitrary data destinations via arbitrary topologies. This allows the selection or fusion of data sources, their interconnection with selected signal processing, statistical processing, pre-visualization operations, and visualization parameters.

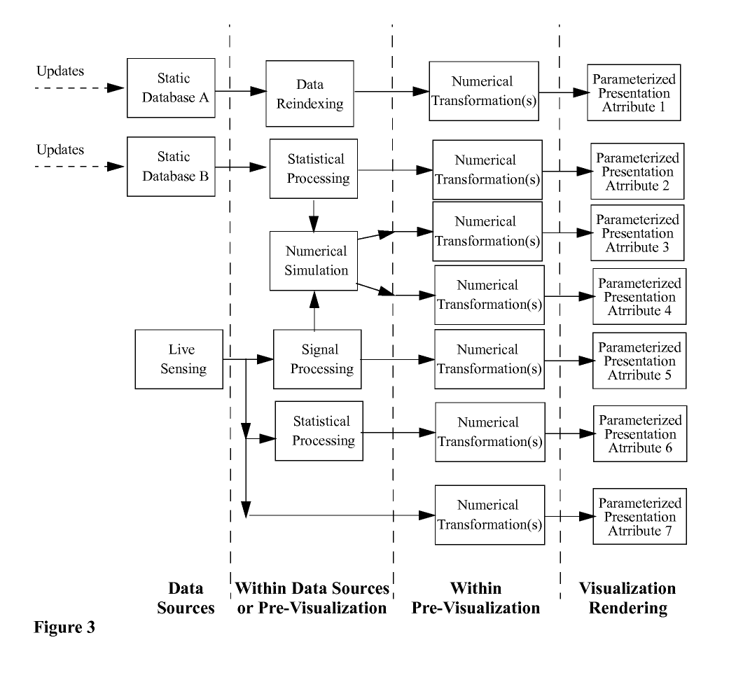

FIG. 3 depicts a topological interconnection of data flow paths linking various elements depicted in FIG. 1. In various embodiments, functions such as data re-indexing, statistical processing, and signal processing can be provided as the data sources depicted in FIG. 1 or as the pre-visualization functions depicted in FIG. 1. Similarly, numerical simulations, for example (but not limited to) those rendered by the computer running a spreadsheet program, a high-performance or other computer, can serve as the data sources depicted in FIG. 1. Certain pre-visualization functions, for example linear predictors, can be regarded as a numerical simulation.

The invention provides for some or all of the data flow paths (such as depicted in the example of FIG. 3) to be specified in any convenient way, for example graphically via an interactive GUI or via a character-based language (interconnection, specification, and data-flow, etc.). A GUI can permit the rendering of a graphic similar to that of FIG. 3. A GUI can permit creation and customization of instances of functional blocks such as the ones depicted in FIG. 3 from a library, menu, or graphical pallet. A GUI can be used to create and link these customized instances of functional blocks, via link-by-link “drawing,” with a data path topology such as the ones depicted in FIG. 3.

Various types of user interfaces may be used to create configurations such as that of FIG. 3 and set the various parameters within it. As one example approach, the selection of function blocks and the general connectivity among them can be specified using a drawing tool and a palette of function blocks, and clicking on each function block would cause dialog windows to appear that can be used for setting parameters. The parameters can be set by means of typed-in values, sliders, mouse manipulation, or the advanced high-dimension user interface devices to be described later in the specification. More generally, a wide range of approaches, styles, and forms of configuration-specification, feature-selection, and parameter-setting GUIs are known in the art. A few example user interfaces or aspects of them will be mentioned to showcase aspects, but a comprehensive treatment of user interface approaches is not necessary for enablement as general forms of configuration specification GUIs and parameter setting GUIs are known in the art. A number of example configuration-specification, feature-selection, and parameter-setting GUIs will be the subject of a later companion patent application.

### Pre-Visualization Operations

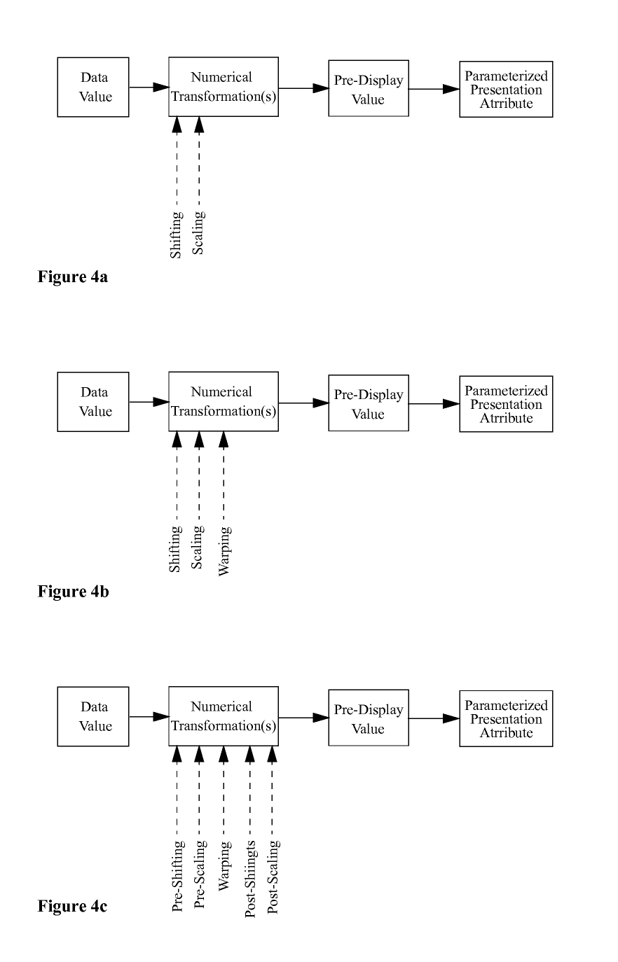

Attention is now directed to consideration of pre-visualization operations. FIGS. 4a-4c depict an approach for mapping a data value lying within a pre-defined range to a value within a pre-defined range for a parameterized data or cell presentation attribute. In most cases the input data range must be at least scaled and shifted to match the pre-defined range for a parameterized presentation attribute. This (linear or affine transformation) arrangement is depicted in FIG. 4a. In some circumstances it can also be desirable to warp the data range with nonlinearity. A library of fixed or adjustable nonlinearities is provided which are such that the input and output of the nonlinearity both match the pre-defined range for a parameterized presentation attribute. This arrangement is depicted in FIG. 4b. The warping effect is provided with additional flexibility by allowing pre-scaling and pre-shifting prior to applying a selected nonlinearity and subjecting the outcome of the nonlinear warping to post-scaling and post-shifting operations in order to match the resulting range to the pre-defined range for a parameterized presentation attribute. This arrangement is depicted in FIG. 4c. Features and parameters of the operations described above can be selected via user interface dialog windows. General forms configuration-specification, feature-selection, and parameter-setting GUIs are known in the art.

FIG. 5 depicts a more general view and organization of pre-visualization operations provided for by the invention. In this example, available pre-visualization operations include:
Data indexing/re-indexing, data sorting, data suppression, and similar types of data operations;
Normalization, shifting (translation), and other types of linear and affine transformations;
Linear filtering, convolution, linear prediction, and other types of signal processing operations;
Warping, clipping, nonlinear transformations, nonlinear prediction, and other nonlinear transformations.
The invention provides for other types of pre-visualization operations as well.
   Features and parameters of the operations described above can be selected via user interface dialog windows. General forms configuration-specification, feature-selection, and parameter-setting GUIs are known in the art.

The invention also provides for the inclusion of statistical operations and statistical processing functions and for the linking to external programs to perform other types of pre-visualization operations. Features and parameters of these can be selected via user interface dialog windows. General forms configuration-specification, feature-selection, and parameter-setting GUIs are known in the art.

The invention also provides for external programs to be added to the collection of available pre-visualization operations.

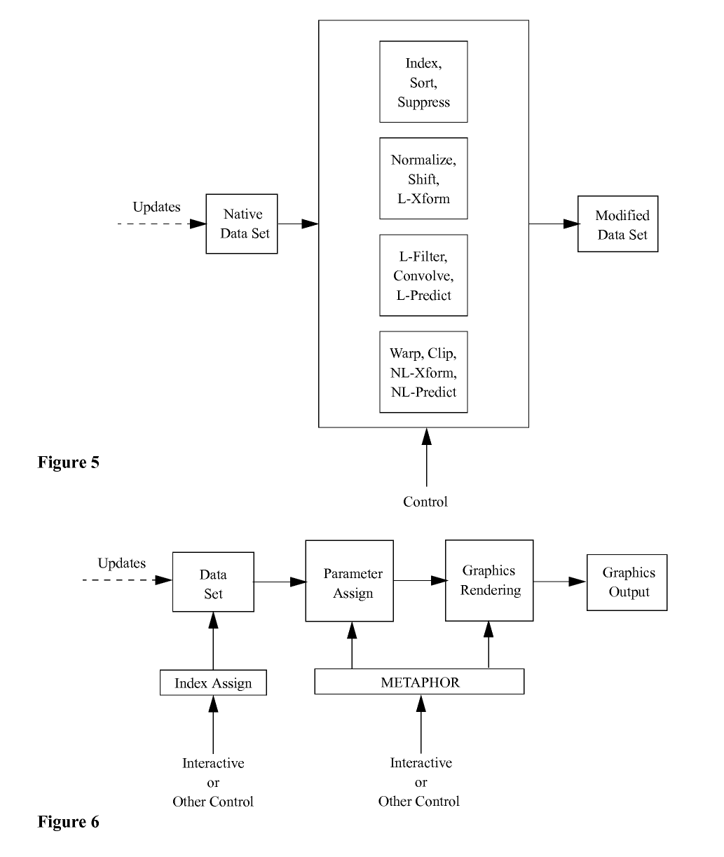

The invention additionally provides for the inclusion and use of visual metaphors to simplify visualization setup and user interaction for data exploration. As an example, FIG. 6 depicts a selected metaphor used to automatically generate parameter assignments and graphics rendering operations. The invention provides for metaphors to control other aspects of the visualization and pre-visualization operations. The invention provides for a metaphor to base its operations on characteristics of a data set being visualized, previously visualized, and anticipated to be visualized. The invention additionally provides for metaphors to be selected and controlled by user interaction, data values, or other means. Features and parameters of the operations can be selected via user interface dialog windows. General forms configuration-specification, feature-selection, and parameter-setting GUIs are known in the art.

The invention also provides for array (vector, matrix, tensor) operations such as (vector, matrix, tensor) linear combinations, (vector, matrix, tensor) multiplication, scalar multiplication, finding (matrix, tensor) determinants, finding (matrix, tensor) inverses and psuedoinverses, row reduction, factorization, change of basis, or calculation of an eigensystem (eigenvalues, eigenvectors, eigentensors).

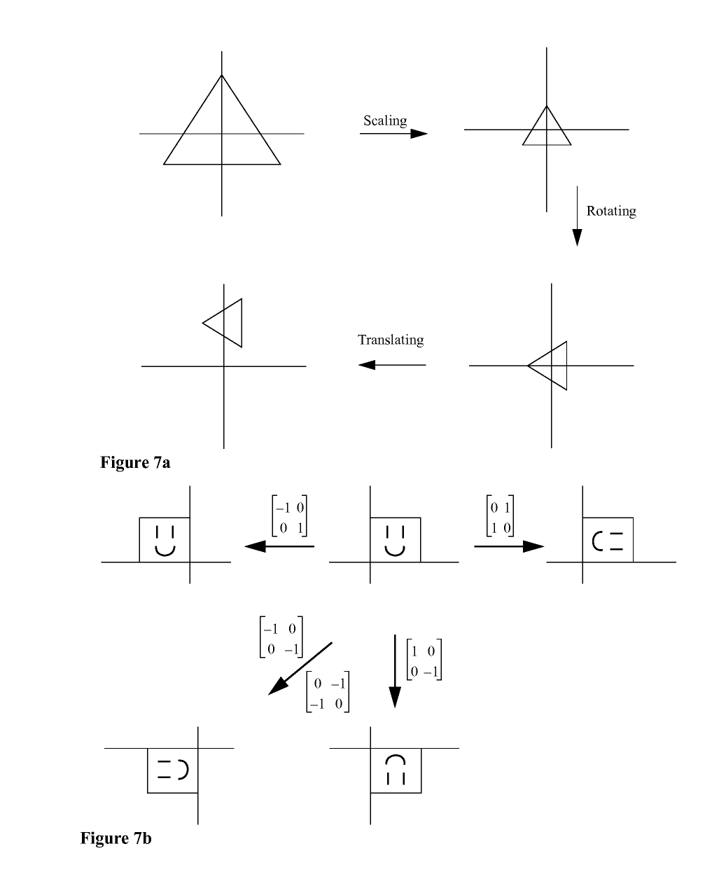

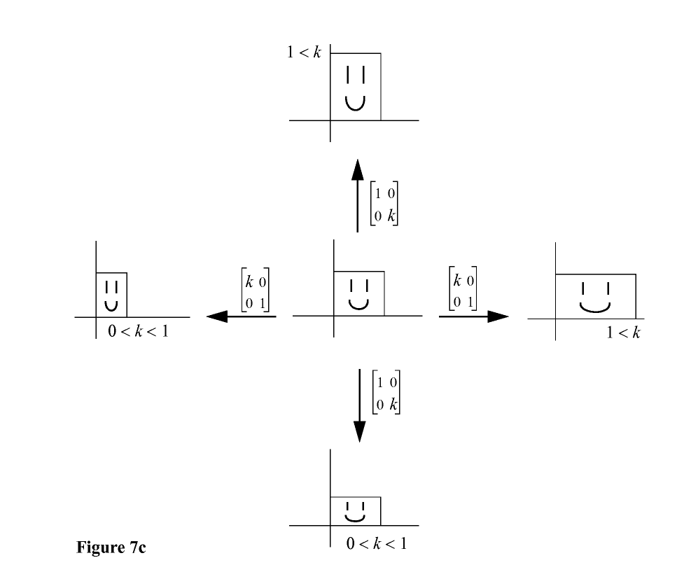

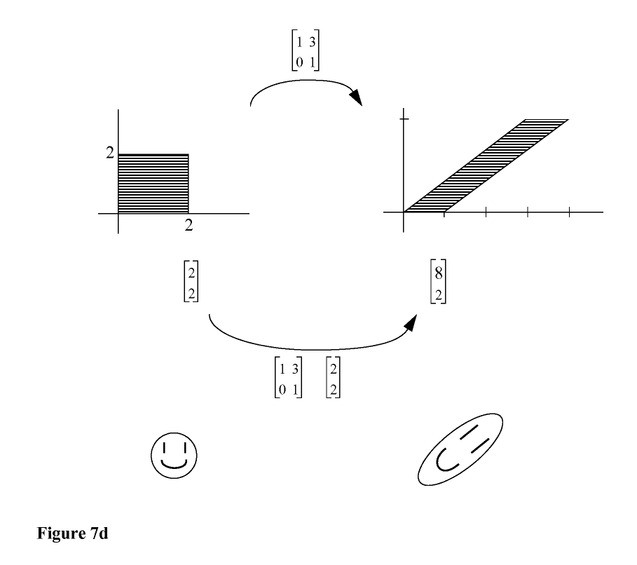

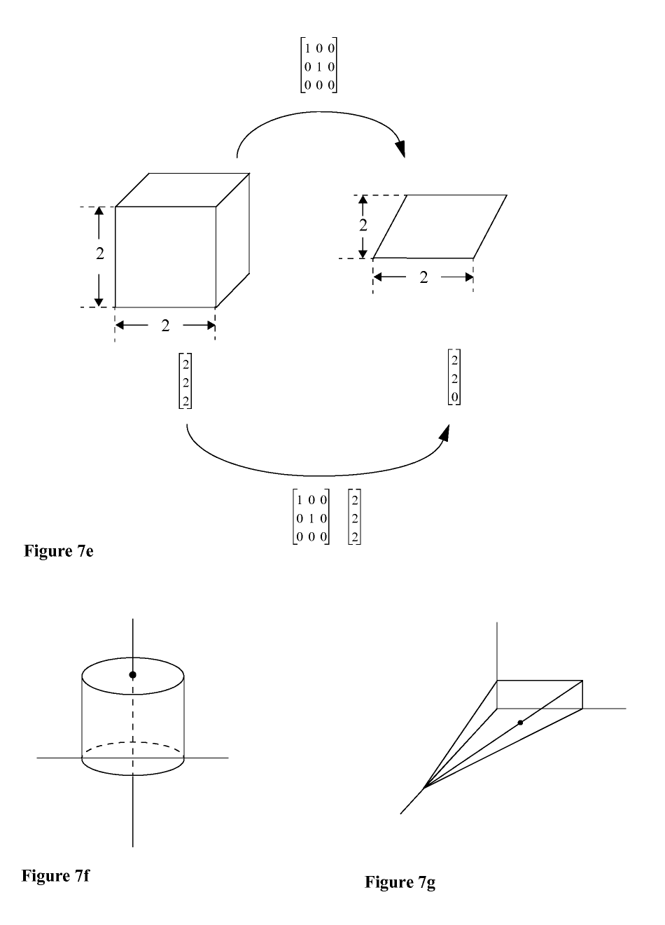

The invention can additionally transform a graphics object via matrix operations. As examples, FIG. 7a illustrates a 2D graphic object being resized, rotated, and shifted through array-based scaling, rotating, and translating linear transformations. FIG. 7b illustrates processes of a 2D graphic object being rotated around x-axis, y-axis, line of y=x, and line of y=−x. and FIG. 7c illustrates processes of 2D graphic object being rescaled vertically or horizontally. FIG. 7d illustrates a transformation process acting on 2D graphics objects such as a rectangle-bounded horizontal line array and a graphic. The invention also provides to extend these and related systems and methods to transform 3D-graphics via scalings, rotations, stretch, etc.

The invention provides for dimensional transformations among points, 1D, 2D, and 3D graphics objects. FIG. 7e illustrates a matrix or tensor transformation process and how it changes a 3D graphics object into a 2D object via dimension dropping. FIG. 7f illustrates a 3D graphics object rendered of a 2D surface created by a vertical line rotated around the y-axis. FIG. 7g illustrates a 3D graphics object rendered by perspective projection defined by a point.

The invention also provides for 3D graphics generation from one or more of 3D vector draw-lists provided by other programs, spreadsheet data, and the user. The invention also provides for 3D graphics generation from equations provided by the user.

The invention further provides for pre-visualization operations to themselves have parameters that can be adjusted in real time or be stored in files for recall.

The invention further provides for a network of pre-visualization operations to be stored in files for recall.

### Provisions for Spreadsheet Visualization

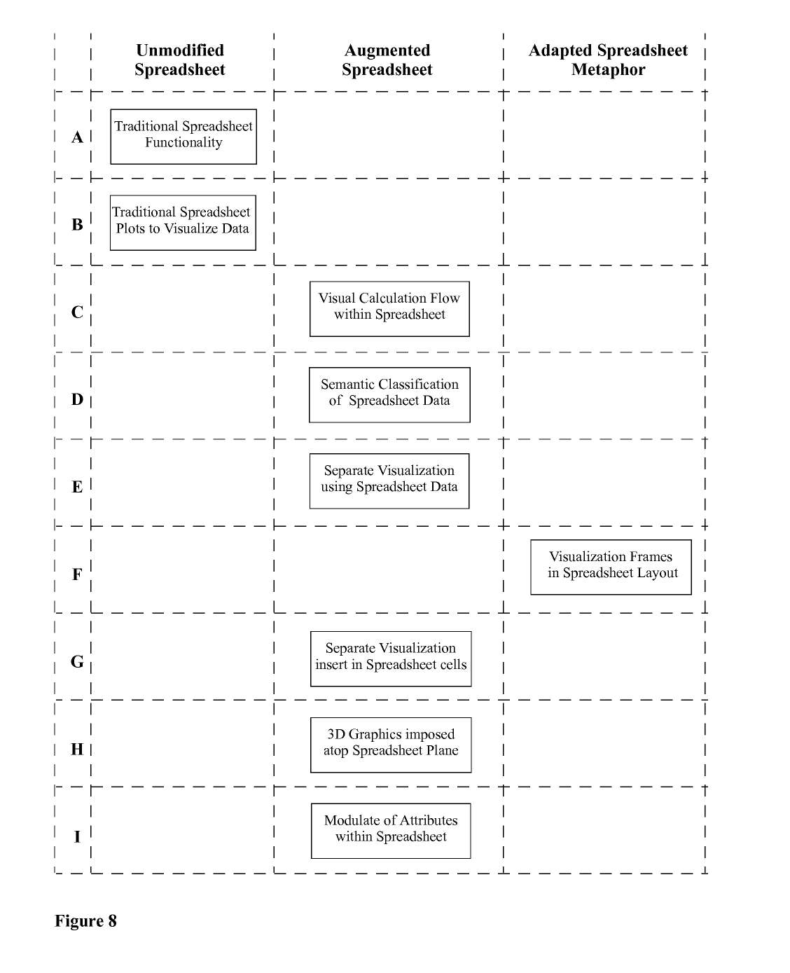

The visual data representation successes of spreadsheets suggest additional opportunities for providing and combining additional data visualization capabilities with the well-established functionality and embedded deployment of spreadsheet software. FIG. 8 provides an example of ways in which data visualization and spreadsheets can be integrated. The present invention provides several additional data visualization capabilities to traditional spreadsheets.

First, traditional spreadsheets present data in a tabular form leveraging row, column, and sheet organization. Traditional spreadsheets typically include plotting routines that create graphical representation of selected data points. These plots can be used to provide visual representations of data and mathematical functions. These spreadsheet functions provide a base-level form of data visualization based on data in the spreadsheet, as represented in rows A and B of FIG. 8.

Additional subsequent work has been done to employ data visualization characterizing internals of spreadsheet structure such as information flow, cell formula dependences, and semantic classification. These do not provide visualization of data per se, but can be very useful in understanding the data handling of a given spreadsheet. This is represented in rows C and D of FIG. 8.

Further subsequent work has been done to supplement basic spreadsheet plotting utilities providing richer data plotting capabilities (for example, utilizing 3D graphics). These capabilities enhance the possible data visualization based on data in the spreadsheet. This is represented in row E of FIG. 8.

Yet other subsequent work has been done adopting the interactive format and metaphor of a spreadsheet for use in a tabular presentation of complex data visualization renderings. This is represented in row F of FIG. 8. One aspect of the invention focuses on adapting and significantly expanding this capability. This is represented in row G of FIG. 8.

Still other subsequent work has been done superimposing a third (height) dimension atop the 2-dimensional tabular data layout of an interactive electronic spreadsheet. The third dimension can be used to render color-coded line and surface plots, and the resulting 3D graphics can be viewed from various virtual observation points for inspection. This is represented in row H of FIG. 8. Another aspect of the invention focuses on adapting and expanding this capability.

Traditional spreadsheets also present numerical, textual, and symbolic data in a tabular array of cells, with the numerical, textual, and symbolic data within the cells provided in various font styles and colors, and with various background colors and border styles of the associated cell. Using spreadsheet functions known as “conditional formatting” these font styles and colors, cell background colors, and cell border styles can be controlled by values of data according to hand-specified (through spreadsheet GUI, VBA, APIs, etc.) conditional tests performed on data within one or more specified cells. These spreadsheet functions provide another form of data visualization based on data in the spreadsheet. One aspect of the invention focuses on adapting and expanding this capability. This is represented in row I of FIG. 8.

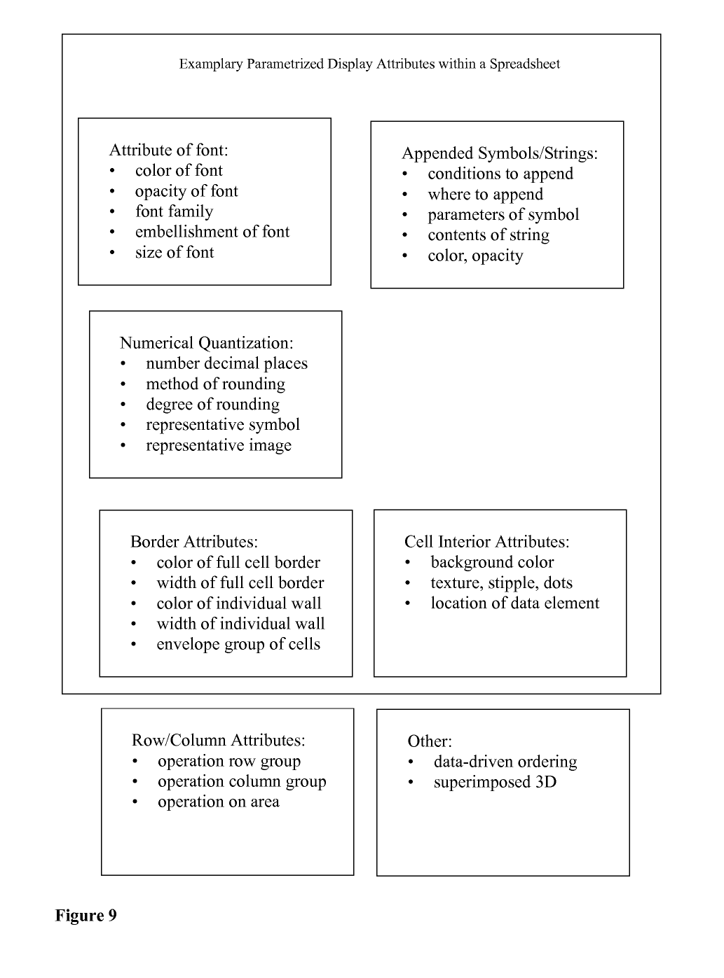

FIG. 9 depicts of data and cell presentation attributes serving as candidates for visualization parameters within a spreadsheet display. Some of these attributes can be controllable under conditional formatting in traditional spreadsheets while others may not be controllable under conditional formatting in traditional spreadsheets. In one aspect of the invention, a data or cell presentation attribute provided a pre-defined range of variability and is controlled by a parameter that can vary over a pre-defined range (for example, between 0 and 1, between 0 and 100, between −1 and +1, etc). This parameter-controlled variability of a data or cell presentation attribute allows that presentation attribute to be used as a visualization parameter.

For those data and cell presentation attributes that have been controllable under “conditional formatting” in traditional spreadsheets, the parameter-controlled variability provided for by the invention is fundamentally different in a number of ways. A few of these include:
Conditional formatting provides a particular custom-specified result for satisfaction of a custom-specified rule;
For each individual result desired, a corresponding hand-specified rule must be entered; for example in order to span 64 color steps, 64 hand-specified rules must be hand-entered;
In the case of colors, shades, fonts, stipples, etc., conditional formatting provided (or extended by VBA, APIs, etc.) in traditional spreadsheets offers only a small discrete set of choices. In the case of colors, Microsoft Excel for example provides a fixed pre-selected collection of 56 colors, some of which are duplicates. Even if Microsoft Excel provided 64 colors, this would only permit 4 steps per primary color in an RGB color model or a very limited color wheel in a HSB color model. Additionally, the fixed collection of pre-selected colors will always have a significant portion of colors that will be unusable as foreground or background colors as they will not be able to visibly stand out, respectively, against a corresponding range of background or foreground colors. Thus there are typically considerably less than the full collection of pre-selected colors to work with in a given color-control data presentation visualization if numeric or text information is co-displayed.
   Clearly the spreadsheet visualization technology taught in pending U.S. Patent Application 61/239,349 provides a far superior approach with greater capability, practicality, and ease of use.

Among other capabilities, the spreadsheet visualization as taught in pending U.S. Patent Application 61/239,349 provides new visualization capabilities to spreadsheet presentation, spreadsheet formatting, spreadsheet data handling, and spreadsheet interactive use in ways well-suited for use as a numeric-intensive data visualization tool.

The invention provides for visualizations to be co-rendered with the spreadsheet program. The invention provides for visualizations displayed on a specified region of a spreadsheet. The invention provides for the result of visualizations to be exported to outside of the spreadsheet program.

The invention provides implementation of at least some of the invention's spreadsheet presentation features through use of APIs of existing spreadsheet products. The invention provides implementation of at least some of the invention's spreadsheet presentation features with relatively small augmentation and modification of existing product software by product manufacturers.

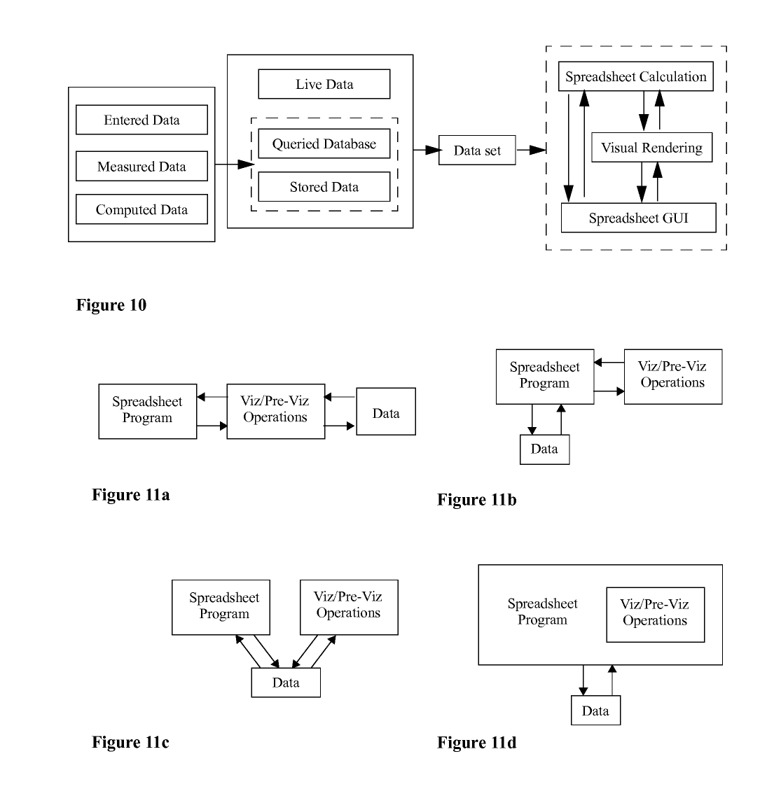

FIG. 10 depicts an example of a spreadsheet architecture (right side) and an information flow as it might be used in a data visualization setting. One of or some combination of entered data, measured data, and computed data can be stored as stored data or stored in a queriable data base. In some situations live data feeds can also provide data. One or some combination of these data sources can be used to provide a data set used by the spreadsheet program. The spreadsheet program internally comprises at least a GUI component, a calculation compound, and a visual rendering component.

FIGS. 14a-14d depicts various types of relationships and information flows among a system or method for rendering a conventional spreadsheet or table of tabular data, a system or method for rendering the visualization operations of the invention, and a data set used by each. Visualization and pre-visualization operations can be introduced between the data and the spreadsheet program as depicted in FIG. 11a. Visualization and pre-visualization operations can obtain data from the spreadsheet program, process data, and return the generated visual operation back to the spreadsheet program as depicted in FIG. 11b. An example of this is using an API or the use of VBA in conjunction with Microsoft Excel.

Visualization and pre-visualization operations can also be implemented as parallel operations to the spreadsheet program. Visualization and pre-visualization operations can be configured separately as an independent operation(s) with direct access to data (i.e., able to obtain data and send the result to the data without having to go through the spreadsheet program), as shown in FIG. 11c. One advantage of this is that relevant categories of data can be extracted to generate complicated visualizations without the data being arranged into table form. Visualization and pre-visualization operations can be part of a spreadsheet program without direct access to the data, as depicted in FIG. 11d.

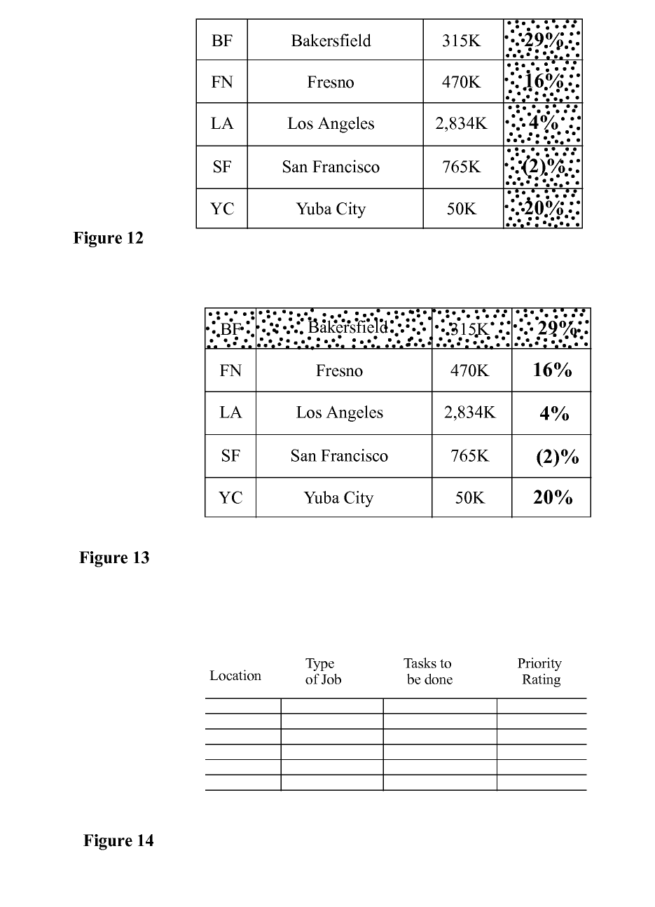

The invention provides for visual aspects of groups of cells to be varied together as a function of a data value. For example, FIG. 12 depicts a visualization wherein an attribute of a column area of data elements is varied as a group. In this example a set of collected data containing the state, main industry, population, the increase in population, number in current work force, unemployment rate, and the increase in unemployment rate can be used for different purposes. Depending on what category the emphasis is on, an attribute of that column can be varied. Such emphasis can be done by varying the font boldness, font size, or font color. FIG. 13 depicts a visualization wherein the shading of a row area of data elements is varied as a group as a function of a data value and also wherein the font boldness of a column area of data elements is varied as a group as a function of another data value. Configurations, features and parameters for related operations, such as data set selection, data ranges, offsets, scalings, warping functions, etc., can be, for example, selected via traditional types of user interface dialog windows. General forms configuration-specification, feature-selection, and parameter-setting GUIs are known in the art.

The invention provides for a reordering of tabular rows and columns as a function of data values. Unlike a traditional spreadsheet data sort, such a reordering operates as a “live” function, responsive to interactive changes of the underlying data values. FIG. 14 illustrates a model of a priority queue wherein the rows can automatically reorder among themselves as underlying priority sales change. Jobs to be done can have different attributes, such as location or types of jobs along with numbers that indicate the rating of priority. A user would expect jobs with a higher priority rating to be displayed in a higher position of the priority queue tree listing and to reorder as calculated priority values change. Configurations, features and parameters for related operations, such as data set selection, data ranges, offsets, scalings, warping functions, etc., can be, for example, selected via traditional types of user interface dialog windows. General forms configuration-specification, feature-selection, and parameter-setting GUIs are known in the art.

The invention provides for interactive tabular spreadsheet metaphor for presentation of visualization renderings. A cell may be selected and the data used to create the enclosed visualization can be captured (as structured for the enclosed visualization) to be used in a subsequent visualization or calculation. A cell may be selected and the pre-visualization dataflow and processing steps used to create the enclosed visualization can be captured (as structured for the enclosed visualization) to be used in a subsequent visualization or calculation. A cell may be selected and the visualization format employed by the enclosed visualization can be captured (as structured for the enclosed visualization) to be used in a subsequent visualization or calculation.

Two cells can be selected and the data used to create the enclosed visualizations can be captured (as structured for the enclosed visualization) and provided to a mathematical operation (for example, adding, subtracting, multiplying, convolving, etc.) to form a new dataset to be used in a subsequent visualization or calculation. Similarly, multiple cells can be selected and the data used to create the enclosed visualizations can be captured (as structured for the enclosed visualization) and merged to form a new dataset to be used in a subsequent visualization or calculation. Embodiments of the spreadsheet visualization as taught in pending U.S. Patent Application 61/239,349 can also include one or more of the following optional features:
At least part of the captured data can be re-sampled, redundant data occurring in the merged dataset can be removed;
Gaps in data occurring in the merged dataset are noted; gaps in data occurring in the merged dataset can be filled in via interpolating functions;
At least one partial row and at least one partial column can be selected and an operation applied to the underlying data;
At least one partial row and at least one partial column can be selected and an operation applied to the individually enclosed visualizations;
At least one partial row and at least one partial column can be selected and at least one attribute or parameter of a common visualization operation can be adjusted and applied to each of the individually enclosed visualizations;
At least one partial row and at least one partial column can be selected and at least one attribute or parameter of a common pre-visualization operation can be adjusted and applied to each of the individually enclosed visualizations;
At least one partial row and at least one partial column can be selected and at least one attribute or parameter of a common data source selection can be adjusted and applied to each of the individually enclosed visualizations.

### Exemplary 3D Graphics Augmentations to Spreadsheet Visualizations

The invention provides for the inclusion of useful novel 3D graphics visualization functions for multidimensional data representation, data query, and numerical solution tools for simultaneous interactive numerical equations. These can be incorporated in various ways, as described below, to expand spreadsheet—based visualization capabilities yet further.

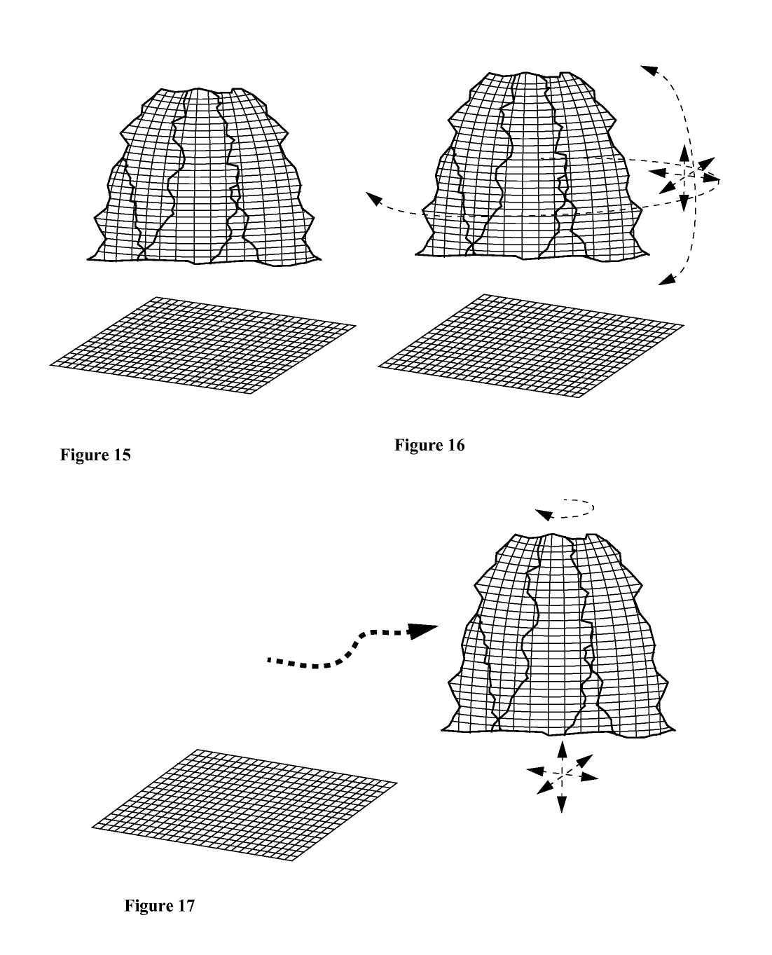

A first set of the useful novel 3D graphics visualization functions provided for by the invention pertain to multidimensional data visualizations based on 2D-surfaces embedded in a 3D visual field. FIG. 15 shows a 3D data visualization and a spreadsheet separated by a vertical gap within a 3D visual field as provided for by the invention. The invention also provides for interactively shifting the observation point with respect to these objects for more detailed feature, theme, or trend inspection. The viewpoint can be changed according to the 6 degrees of freedom (three translations, three angles) of rigid motion. FIG. 16 depicts with dashed lines a few ways in which the observation viewpoint can be moved with respect to these abstract objects. The viewpoint can be changed under the control of a high dimensional user interface device such as an HDTP or advanced mouse to described later.

The invention also provides for moving the 2D-surface representing a 3D data plot within the 3D visual field. The 2D-surface can be moved according to the 6 degrees of freedom (three translations, three angles) of rigid motion. FIG. 17 depicts a translation and rotation of a 3D data plot within the 3D visual field. The 3D data plot can be moved under the control of a high-dimensional user interface device such as an HDTP or an advanced mouse.

The 2D-surface representing a 3D data plot within the 3D visual field can be virtually illuminated by one or more lighting sources. The one or more lighting sources can be moved according to the 6 degrees of freedom (three translations, three angles) of rigid motion. The one or more lighting sources can also permit control of the color and intensity of virtual light emitted. A lighting source can be moved and controlled via a high-dimensional user interface device such as an HDTP or an advanced mouse.

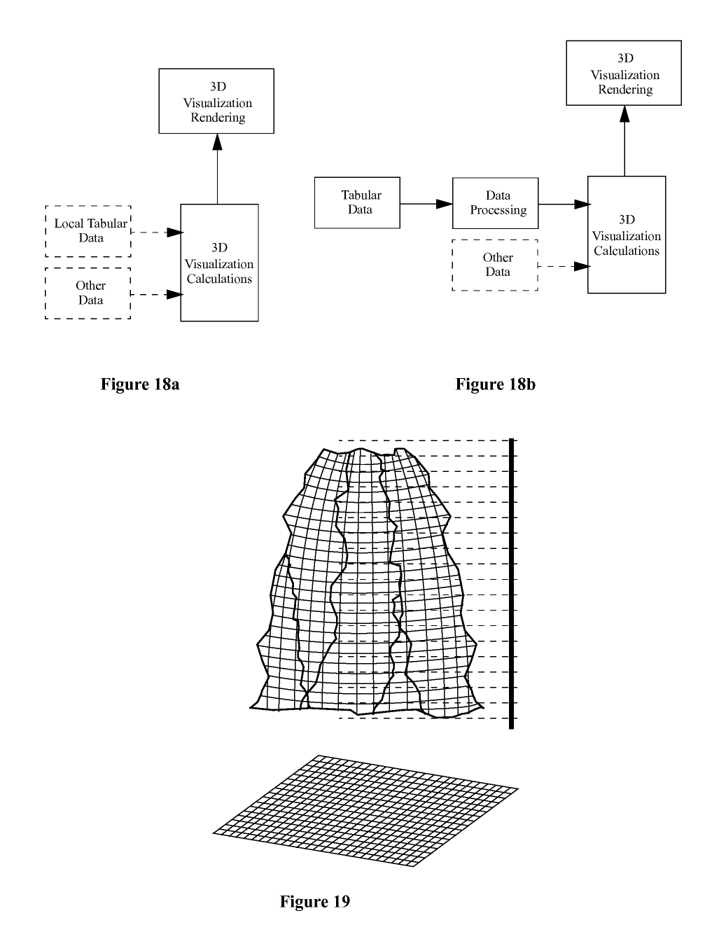

The data plotted in the 2D-surface representing a 3D data plot within the 3D visual field can directly echo the data displayed in the planar array of associated tabular data or spreadsheet and can originate from another set of tabular data or spreadsheet region or from other data. This is suggested by FIG. 18a. The invention also provides for processing of the data via mathematical transformations, statistical processing, signal processing, etc. prior to creation of the 2D-surface representing at least 3-dimensional data. This is suggested by FIG. 18b. The 2D-surface representing at least 3-dimensional data can plot filtered or averaged versions of tabular data, spreadsheet data, or other data, and the filtering or averaging can be controlled by an interactive parameter.

The invention provides for 2D-surface representing of at least 3-dimensional data to be rendered along with a height measuring visual so that the local color of the surface need not be a function of the vertical value being plotted. This frees up the local 2D-surface color to be used to represent an additional dimension of data. FIG. 19 illustrates a height measuring visual in its use with 2D-surface representing at least 3-dimensional data and useful for representing at least 4-dimensional data.

The invention provides for a 2D-surface representing at least 3-dimensional data to be rendered with a parameterized locally varying surface texture that can be used to represent an additional dimension of data, with numerical values rendered on the surface that can be used to represent an additional dimension of data, with symbols rendered on the surface that can be used to represent an additional dimension of data, or with parameterized glyphs rendered on the surface that can be used to represent (an) additional dimension(s) of data.

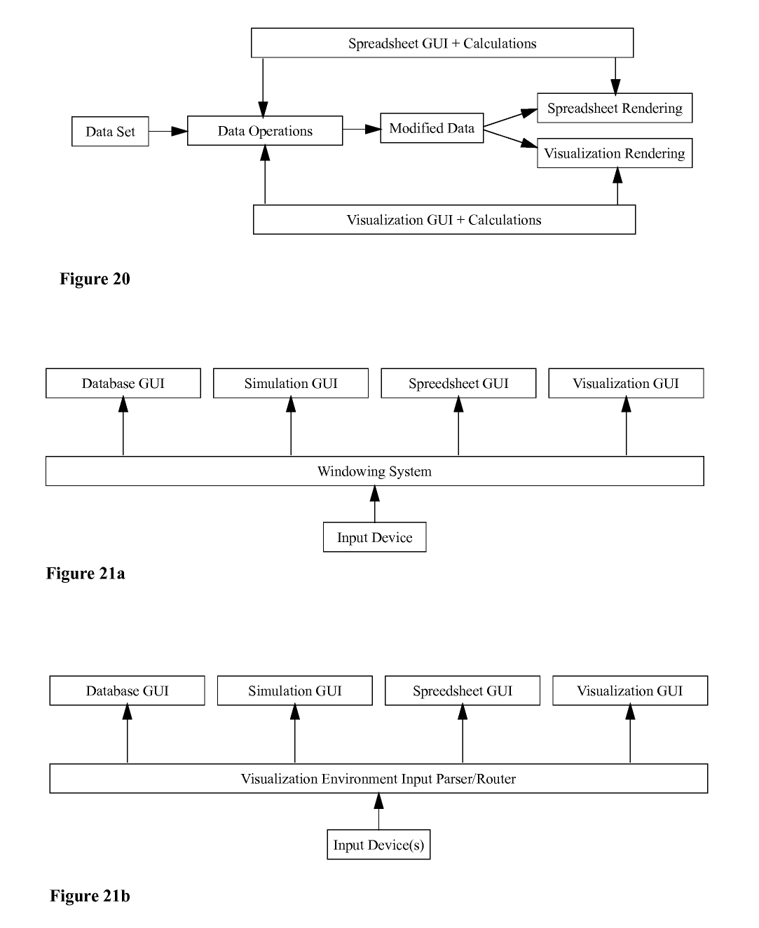

Next, user interface architectures for general visualization and spreadsheet visualization environments are considered. FIG. 20 depicts an augmentation of a spreadsheet program with additional spreadsheet features as provided for by the invention. A data set is subjected to data operations so as to produce modified data. The data operations can be controlled by the spreadsheet GUI and spreadsheet calculation as well as by the visualization GUI and Visualization calculations.

### Visualization User Interface Architectures: Traditional and High-Dimension User Interface Devices (HDTP and Advanced Mice)

FIGS. 21a and 21b depict ways in which one or more user interface input devices (such as a mouse, trackball, touchpad, etc.) can be managed to control graphical user interfaces of a plural software application in the context of the invention. FIG. 21a, the windowing system directs the input events from a single user interface input device to various applications, for example, a Database GUI, a Simulation GUI, a Spreadsheet GUI, and a Visualization GUI. FIG. 21b depicts an alternative implementation wherein a Visualization Environment Input Router/Parser accepts input events from one or more user interface input devices and directs these events to each of the various applications. The Visualization Environment Input Router/Parser can direct events from multiple user interface input devices to different inputs to the same application. The Visualization Environment Input Router/Parser can split events originating from an individual user interface device and separately route these to inputs of separate applications. A Visualization Environment Input Router/Parser can work together with the Window System to route input events.

The above arrangements are general and apply to use of conventional mice, trackballs, touchpads, etc. However, visualization and CAD workstations have often been provided with more sophisticated user input devices that provide a higher number of interactive simultaneously-adjustable parameters. Classic examples of this are knob-boxes (as used in HP and SGI workstations), the DataGlove (VPL, General Reality), the SpaceBall (Logitech3Dconnexion, Labtec, HP/Compaq), etc., although few of these have survived product cycles to remain in active use or with wide availability. More recently enhanced touch-based interfaces have attracted a great deal of attention, mostly for their multi-touch and gesture recognition capabilities. However, some enhanced touch-based interfaces such as the HDTP (“High Dimensional Touch Pad,” U.S. Pat. No. 6,570,078; U.S. patent application Ser. Nos. 11/761,978 and U.S. Ser. No. 12/418,605, among others) employ a tactile sensor array (pressure, proximity, etc.) and real-time image and mathematical processing to provide a powerful user input device with both a higher number of interactive simultaneously-adjustable parameters and a rich range of syntactic and metaphorical capabilities well-suited to use with interactive visualization. Additionally, the HDTP technology can be readily implemented as a touchscreen through use of, for example, inexpensive transparent capacitive proximity-sensor arrays. The present invention provides for the incorporation and use of the HDTP and other metaphor-rich user interface input devices into visualization environments. Attention is now directed to incorporation of the HDTP as part of a visualization environment user interface and then brief attention is directed to alternative use of a few alternative metaphor-rich enhanced user interface technology approaches.

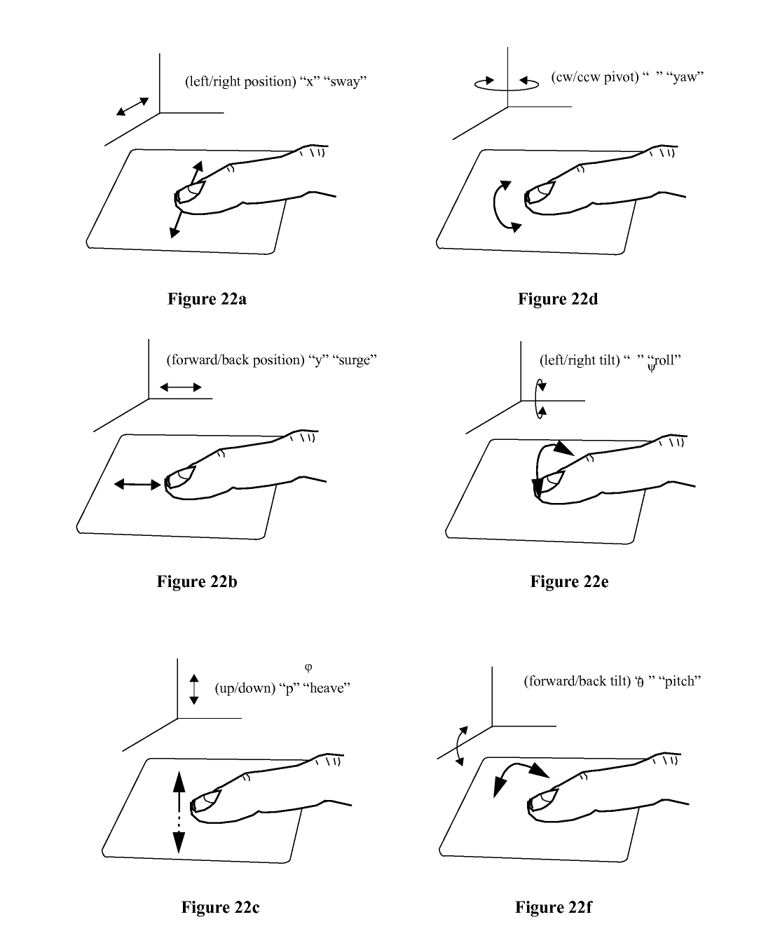

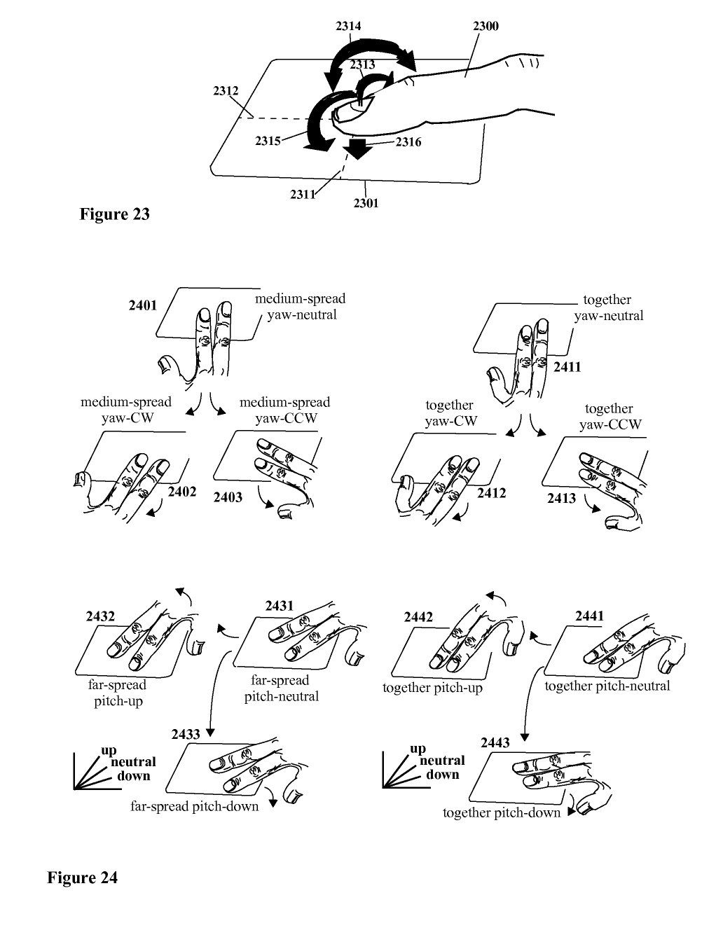

FIGS. 22a-22f illustrate the six independently adjustable degrees of freedom of touch from a single finger that can be simultaneously measured by the HDTP technology. The depiction in these figures is from the side of the touchpad. FIGS. 22a-22c show actions of positional change (amounting to applied pressure in the case of FIG. 22c) while FIGS. 22d-22f show actions of angular change. Each of these can be used to control a user interface parameter, allowing the touch of a single fingertip to control up to six simultaneously-adjustable quantities in an interactive user interface. FIG. 23 suggests general ways in which two or more of these six independently adjustable degrees of freedom 2311-2316 can be adjusted at once for a finger 2300 in contact with an HDTP sensor surface 2301. More advanced implementations of the HTDP provide for multi-touch capabilities far more sophisticated than those popularized by the Apple iPhone, NYU, and others.

FIG. 24 demonstrates a few two-finger multi-touch postures and gestures from the hundreds that can be readily recognized by HTDP technology. The two fingers may be spread apart somewhat, as in the cases 2401-2403 and 2431-2433, or may be brought together, as in the cases 2411-2413 and 2441-2443. The separation of the two fingers adds an additional parameter that can be controlled by the user, and the yaw (pivot) parameter may be varied independently from the newly introduced finger separation parameter. For example the hand can pivot clockwise 2402, 2412, or counter-clockwise 2403, 2413 from the corresponding neutral positions 2401, 2411. Similarly, the pitch of the pair of fingers can be raised 2432, 2442 or lowered 2433, 2443 with respect to the corresponding neutral positions 2431, 2441, while independently from these motions the two fingers are spread apart 2431-2433 or brought together 2441-2443. Note the finger spread can be varied considerably in this two-finger posture.

The pair of fingers can be moved as a group through all six degrees of freedom (left-right, forward-back, downward pressure, roll, pitch, yaw), and comfortably allow for two differences between the fingers (differences in downward pressure, and one angle of finger separation spread) and even three differences between the fingers (differences in downward pressure and two coordinates of separation when fingers curl to form independently controlled “x” and “y” components). Thus two-finger postures considered above can readily provide a nine-parameter set relating to the pair of fingers as a separate composite object adjustable within an ergonomically comfortable range. One example nine-parameter set the two-finger postures comprises:

composite (group) average x position;

inter-finger differential x position;

composite (group) average y position;

inter-finger differential y position;

composite (group) average pressure;

inter-finger differential pressure;

composite (group) roll;

composite (group) pitch;

composite (group) yaw.

HTDP technology can also be configured to recognize and measure postures and gestures involving three or more fingers, various parts of the hand, the entire hand, multiple hands, etc. In general, multifinger contact can be used to provide control of up to three additional independently adjustable parameters for each additional finger.

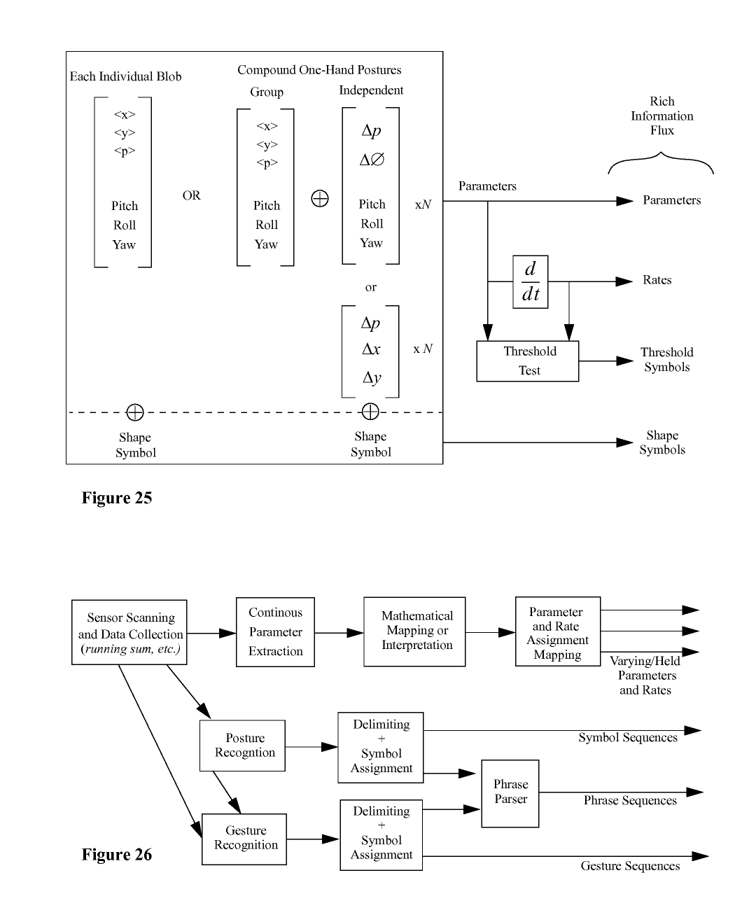

FIG. 25 shows an example of how raw measurements of the six quantities of FIGS. 22a-22f, together with shape recognition for distinguishing contact with various parts of the hand and the touchpad, can be used to create a rich information flux of parameters, rates, and symbols. FIG. 26 shows an approach for incorporating posture recognition, gesture recognition, state machines, and parsers to create an even richer human/machine tactile interface system capable of incorporating syntax and grammars.

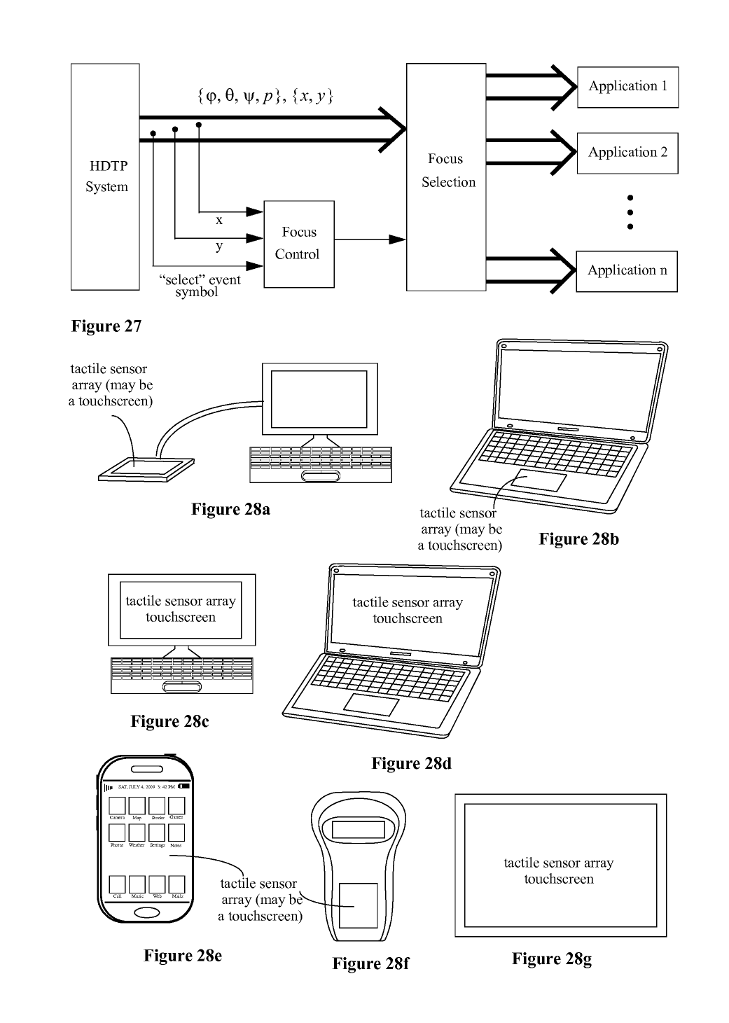

FIG. 27 depicts a user interface input arrangement incorporating one or more HDTPs that provides a user interface input event and quantity routing of the type described earlier in conjunction with FIGS. 16a-16b.

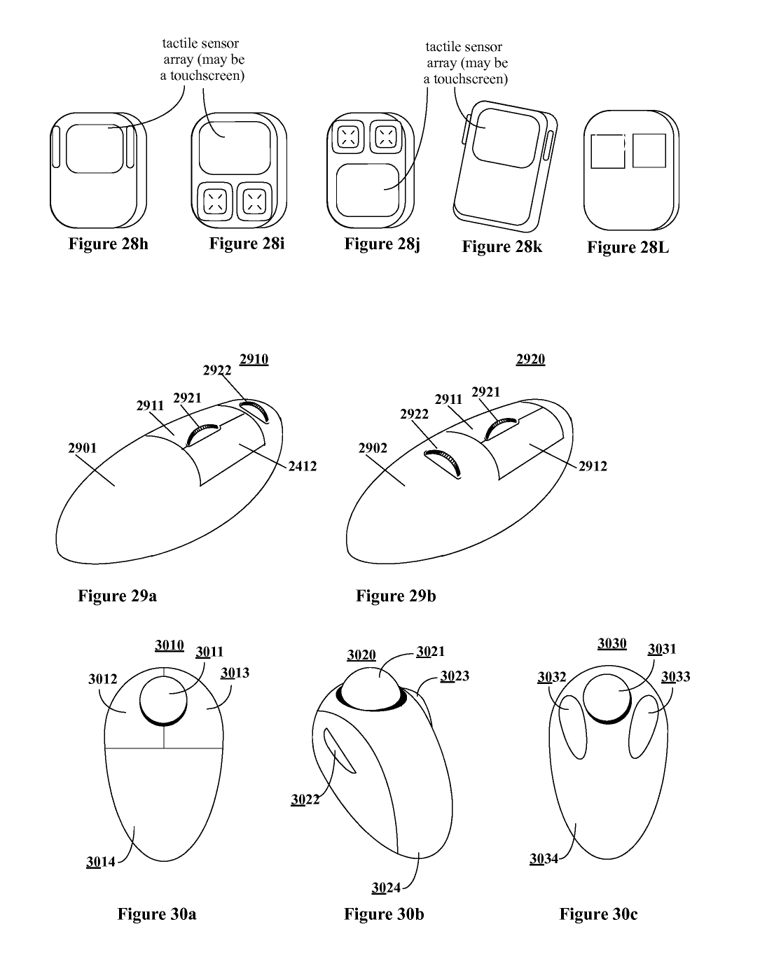

FIGS. 28a-28L depict a number of arrangements employing the HDTP technology suitable for use with visualization environments. FIG. 28a illustrates an HDTP as a peripheral that can be used with a desktop computer (shown) or laptop (not shown). FIG. 28b depicts an HDTP integrated into a laptop in place of the traditional touchpad pointing device. In FIGS. 28a-28b the HDTP tactile sensor can be a stand-alone component or can be integrated over a display to form a touchscreen. FIG. 28c depicts an HDTP integrated into a desktop computer display to form a touchscreen. FIG. 28d shows the HDTP integrated into a laptop computer display to form a touchscreen. FIG. 28e depicts an HDTP integrated into a cellphone, smartphone, PDA, or other hand-held consumer device. FIG. 28f shows an HDTP integrated into a test instrument, portable service-tracking device, portable service-entry device, field instrument, or other hand-held industrial device. In FIGS. 28e-28f the HDTP tactile sensor can be a stand-alone component or can be integrated over a display to form a touchscreen. FIG. 28g depicts an HDTP touchscreen configuration that can be used in a tablet computer, wall-mount computer monitor, digital television, video conferencing screen, kiosk, etc. In at least the arrangements of FIGS. 28a, 28c, 28d, and 28g, or other sufficiently large tactile sensor implementation of the HDTP, more than one hand can be used and individually recognized as such.

FIGS. 28h-28k depict various integrations of an HDTP into the back of a conventional computer mouse. In FIGS. 28h-28k the HDTP tactile sensor can be a stand-alone component or can be integrated over a display to form a touchscreen. More than two touchpads can be included, such as the example of FIG. 28L as taught in U.S. Pat. No. 7,557,797.

The types of human-machine geometric interaction between the hand and the HDTP facilitate many useful applications within a visualization environment. A few of these include control of visualization observation viewpoint location, orientation of the visualization, and controlling fixed or selectable ensembles of one or more of viewing parameters, visualization rendering parameters, pre-visualization operations parameters, data selection parameters, simulation control parameters, etc. As one example, the 6D orientation of a finger can be naturally associated with visualization observation viewpoint location and orientation, location and orientation of the visualization graphics, etc. As another example, the 6D orientation of a finger can be naturally associated with a vector field orientation for introducing synthetic measurements in a numerical simulation. As another example, at least some aspects of the 6D orientation of a finger can be naturally associated with the orientation of a robotically positioned sensor providing actual measurement data. As another example, the 6D orientation of a finger can be naturally associated with an object location and orientation in a numerical simulation. As another example, the large number of interactive parameters can be abstractly associated with viewing parameters, visualization rendering parameters, pre-visualization operations parameters, data selection parameters, numeric simulation control parameters, etc.

In another example, the x and y parameters provided by the HDTP can be used for focus selection and the remaining parameters can be used to control parameters within a selected GUI.

In another example, the x and y parameters provided by the HDTP can be regarded as specifying a position within an underlying base plane and the roll and pitch angles can be regarded as specifying a position within a superimposed parallel plane. In a first extension of the previous two-plane example, the yaw angle can be regarded as the rotational angle between the base and superimposed planes. In a second extension of the previous two-plane example, the finger pressure can be employed to determine the distance between the base and superimposed planes. In a variation of the previous two-plane example, the base and superimposed planes are not fixed as being parallel but rather intersect at an angle associated with the yaw angle of the finger. In each of these examples, either or both of the two planes can be used to represent an index or indexed data, a position, pair of parameters, etc. of a viewing aspect, visualization rendering aspect, pre-visualization operations, data selection, numeric simulation control, etc.

A large number of other examples are possible as is appreciated by one skilled in the art.

One use of the HDTP in the above examples is simply to supply more than the usual two user interface parameters provided by a conventional user interface input device such as a conventional computer mouse, trackball, touchpad, etc. The present invention provides for the use of other user interface input arrangements and devices as alternatives to or in conjunction with one or more HDTPs.

In a simple example, the scroll-wheel of a scroll-wheel mouse is used to provide a third simultaneously adjustable user interface parameter. In another example, a second or yet more additional scroll-wheels can be added to a conventional scroll-wheel mouse. The resultant collection of scroll-wheels can be relatively positioned in parallel, oriented at orthogonal angles to support a coordinate-metaphor, positioned on the sides of the mouse body, etc. FIGS. 29a and 29b illustrate examples 2910, 2920 of a conventional scroll-wheel mouse 2901, 2902 with a traditional up-down scrollwheel 2921 and at least standard mouse buttons 2911, 2912 provided with an added left-right scroll-wheel 2922 as taught in U.S. Pat. No. 7,557,797. Such an arrangement can employ a connecting cable, or the device can be wireless. Each of the arrangements of FIGS. 29a and 29b as well as the ones described in the next paragraph, plus variations and adaptations, will be referred to as an “advanced mouse” or in the plural “advanced mice.”

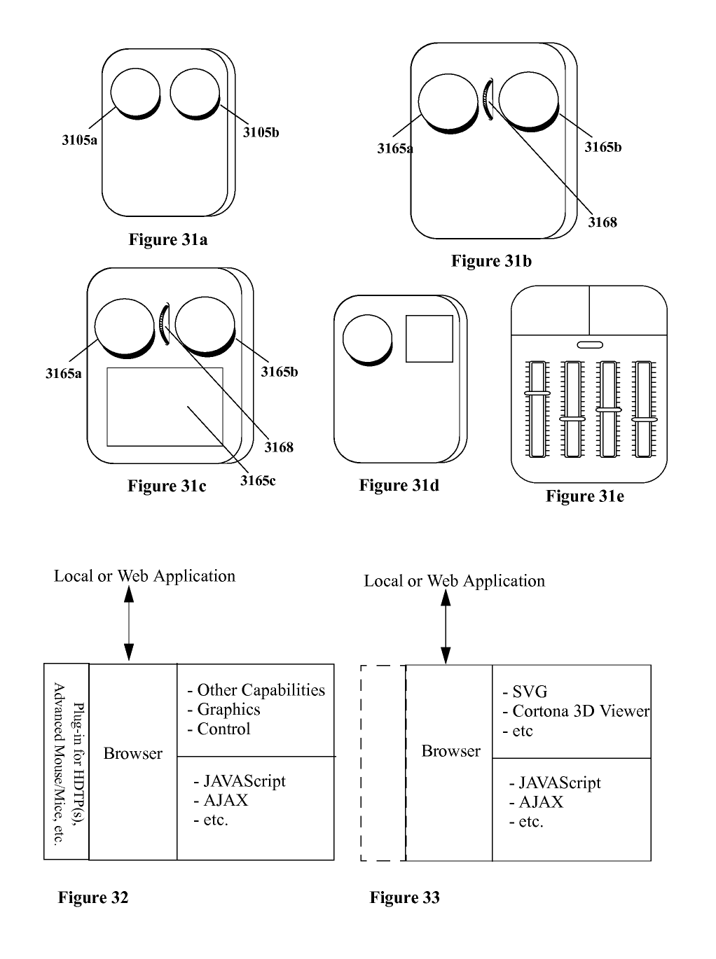

In another example of an advanced mouse, one or more trackballs can be added to a conventional computer mouse. FIGS. 30a-30c illustrate examples 3010, 3020, 3030 wherein a single trackball 3011, 3021, 3031 is incorporated into the back of a conventional computer mouse 3010, 3020, 3030 with at least standard mouse buttons 3012-3013, 3022-3023, 3032-2033 as taught in U.S. Pat. No. 7,557,797. FIGS. 31a-31c illustrate examples where two trackballs 3105a, 3105b are incorporated into the back of a conventional computer mouse as taught in U.S. Pat. No. 7,557,797. The trackballs in the arrangements of FIGS. 30a-30c and FIGS. 31a-31c can be the conventional two degree of freedom type (roll left-right, roll away-towards) or can provide three to six degrees of freedom as taught in U.S. Pat. No. 7,557,797; U.S. patent application Ser. No. 10/806,694. Useful advanced mouse arrangements include the trackball 3105a-3105b, touchpad 3105c, scrollwheel 3168 mouse of FIG. 31c, the trackball/touchpad mouse of FIG. 31d, and the multiple slider configuration of FIG. 30e, each as taught in U.S. Pat. No. 7,557,797. Each of these arrangements can employ a connecting cable, or the advanced mouse device can be wireless.

The additional parameters provided by the HDTP and the above alternatives are more than the usual number supported by conventional window systems (for example as described in conjunction with FIG. 21a). To implement additional parameter handling, for example such as in the HDTP arrangement of FIG. 27 or its equivalents for the alternative advanced mice as described above, additional arrangements must be made beyond the conventional operating system pointer device handling.

In an additional approach, the invention provides for the HDTP or alternatives such as the advanced mice described above to interface with a browser via a browser plug-in. This arrangement can be used to capture the additional user interface input parameters and pass these on to an application interfacing to the browser. An example of such an arrangement is depicted in FIG. 32. The browser can interface with local or web-based applications that drive the visualization and control the data source(s), process the data, etc. The browser can be provided with client-side software such as JAVA Script. Such an arrangement is particularly useful when combined with browser-based rendering of visualizations, as described in the next section.

The invention provides for HDTP parameters to be separated into groups which are individually directed to pointer device interfaces on multiple computers.

### Browser-Rendered Implementations

The invention provides for visualizations to be rendered in a browser. This allows for implementations wherein the browser is used as a viewer. The browser can interface with local or web-based applications that drive the visualization. An arrangement is depicted in FIG. 33. The browser can be provided with Simple Vector Graphics (“SVG”) utilities (natively or via an SVG plug-in) to render basic 2D vector and raster graphics. The browser can be provided with a 3D graphics capability, for example via the Cortona 3D browser plug-in. These alternatives can be provided with client-side software such as JAVA Script. The example of FIG. 33 also provides for other plug-ins (represented by the dashed-line box) such as the user interface input device plug-in described earlier.

### Web-Based Implementations

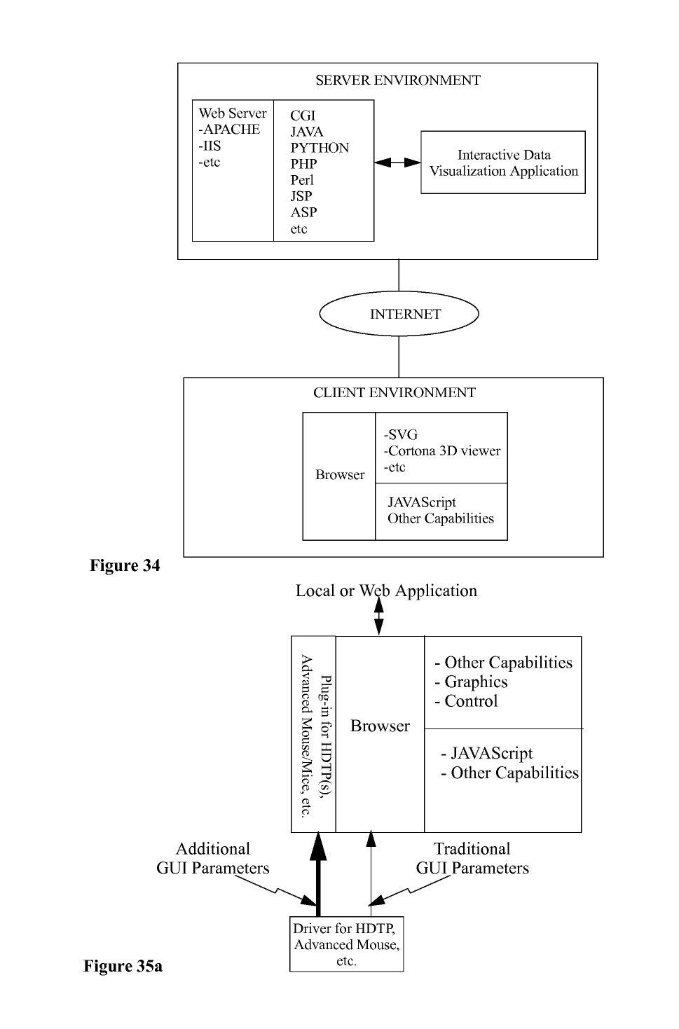

The invention provides for web-based implementations of the visualization environment. FIG. 34 depicts a web-based implementation of a visualization environment leveraging browser arrangements such as that depicted in FIGS. 32-33, their variations, alternatives, etc. As depicted in the arrangement of FIG. 34, the client environment can employ such a browser to access a visualization server environment or visualization-related (databases, live data feeds, simulations, statistical or signal processing, etc.) server environment. The client environment browser can connect over the internet with two or more visualization server environments and visualization-related server environments and local applications. A visualization or visualization-related server environment can connect over the internet with two or more browsers in the client environment. Other variations and alternative implementations are also possible as is clear to one skilled in the art.

A server environment can include web server foundation software such as Apache, IIS, etc. A server environment can also include server-side scripting and dynamic software such as CGI, JAVA/JAVA Script, Python, PHP, Perl, JSP, ASP, etc. Other variations and alternative implementations are also possible as is clear to one skilled in the art.

The additional interactively-controlled parameters provided by the HDTP provide more than the usual number supported by conventional browser systems and browser networking environments. This may be addressed in a number of ways.

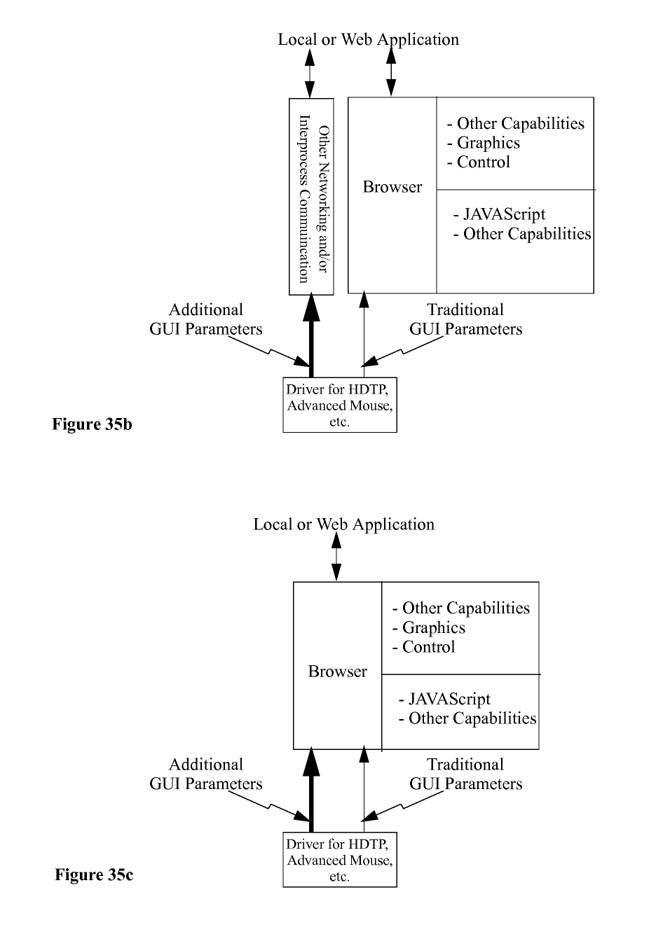

In a first approach, an HDTP interfaces with a browser both in a traditional way and additionally via a browser plug-in. Such an arrangement may be used to capture the additional user interface input parameters and pass these on to an application interfacing to the browser. An example of such an arrangement is depicted in FIG. 35a.

In a second approach, an HDTP interfaces with a browser in a traditional way and directs additional GUI parameters though other network channels. Such an arrangement may be used to capture the additional user interface input parameters and pass these on to an application interfacing to the browser. An example of such an arrangement is depicted in FIG. 35b.

In a third approach, an HDTP interfaces all parameters to the browser directly. Such an arrangement may be used to capture the additional user interface input parameters and pass these on to an application interfacing to the browser. An example of such an arrangement is depicted in FIG. 35c.

The browser may interface with local or web-based applications that drive the visualization and control the data source(s), process the data, etc. The browser may be provided with client-side software such as JAVA Script. The browser may provide also be configured advanced graphics to be rendered within the browser display environment, allowing the browser to be used as a viewer for data visualizations, advanced animations, etc., leveraging the additional multiple parameter capabilities of the HDTP. The browser may interface with local or web-based applications that drive the advanced graphics. The browser may be provided with Simple Vector Graphics (“SVG”) utilities (natively or via an SVG plug-in) so as to render basic 2D vector and raster graphics. The browser also may be provided with a 3D graphics capability, for example via the Cortona 3D browser plug-in.

### Collaboration Implementations

The invention provides for collaboration implementations and the use of collaboration tools for collaborative use of visualization features of the invention and for the creation of a collaborative visualization environment.

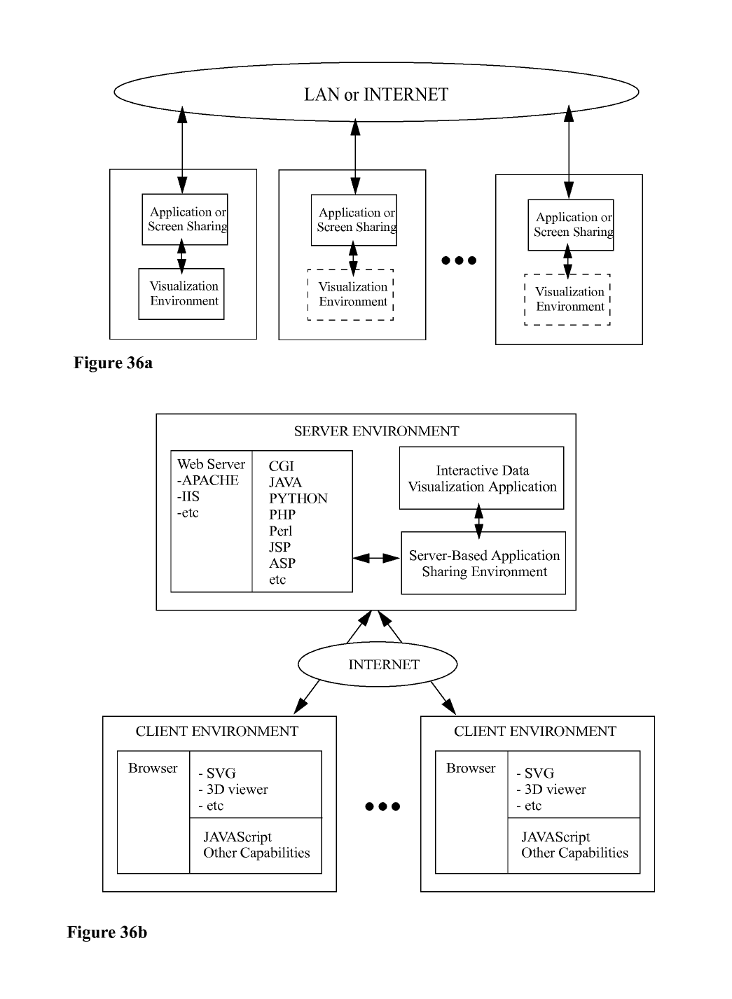

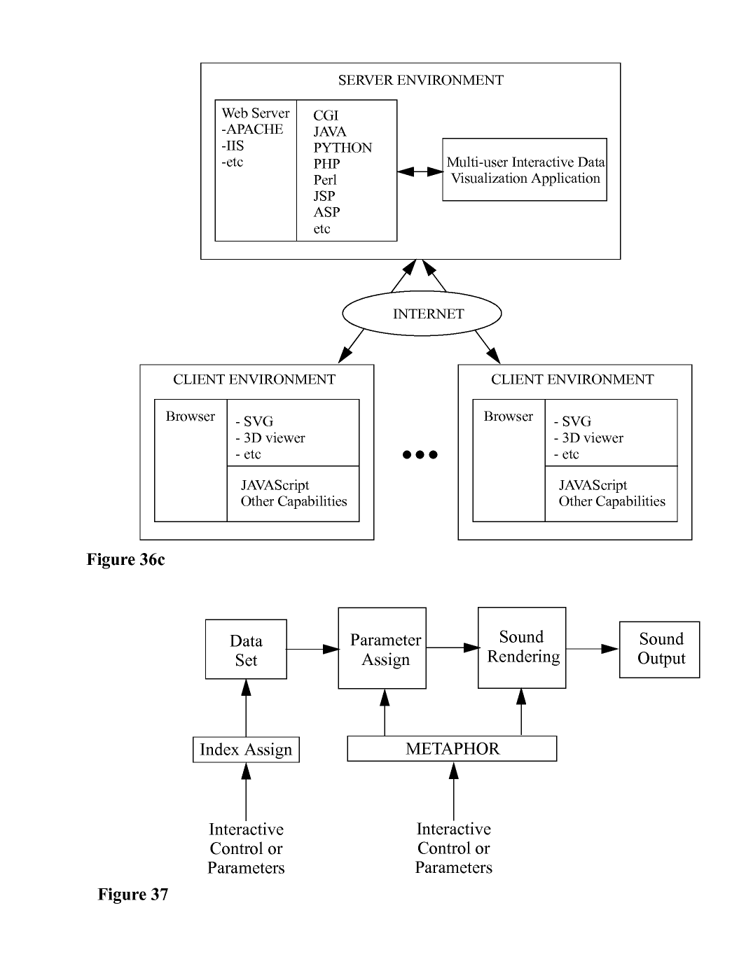

FIG. 36a shows a client-side collaboration implementation wherein a general purpose collaboration tool can be used to share the visualization environment session running on one computer with one or more other computers. The visualization environment can be a stand-alone visualization application or can comprise a browser implementation employing, for example, any of the various arrangements described in conjunction with FIGS. 27-29.

In the case of real-time collaboration, the general purpose collaboration tool employed in the arrangement of FIG. 36a-36c can comprise application sharing software (such as Microsoft's NetMeeting™, IBM/Lotus' SameTime™^{,SM}, HP's Shared-X, etc.) or display sharing software. In the case of real-time collaboration, audio and video conferencing can also be used to facilitate interpersonal communication among collaborating session participants.

FIG. 36b shows server-side collaboration implementation wherein a general purpose or specialized server-side application sharing environment is used to share a server-based interactive data visualization application.

FIG. 36c shows a server-side collaboration implementation comprising a server-based multi-user interactive data visualization application.

Interfacing with Sonification

The invention further provides for interfacing with established and advanced data sonification utilities. Data sonification has received considerable attention and analysis but for the most part is fairly simplistic and often contributes little practical value. More advanced data sonification techniques, such as the multi-channel data sonification system described in U.S. patent application Ser. No. 12/817,196 employed in the environmental GIS (Geographic Information System) process monitoring and modeling system of U.S. patent application Ser. No. 12/817,107, provides new opportunities for practical use of data sonification.

FIG. 37 illustrates a general framework for data sonification where a parameterized metaphor is used to manage parameter assignment and sound rendering and a parameterized data indexing operation.

Data sonification may be applied to the same data used to generate visualization. The data directed to data sonification may be selected by interacting with a rendered visualization via a user interface input device. Data sonification may be provided by a multichannel data sonification system such as the one described in U.S. patent application Ser. No. 12/817,196. Data sonification output may be shared using an audio channel of a real-time collaboration system, may be transmitted from a web-based application using an audio channel as provided by a high-fidelity VoIP system, may be shared using an audio channel as provided by a high-fidelity VoIP system, may be produced local to the user computer under the control of a web-based application, or may be produced local to the user computer under the control of a web-based application employing MIDI protocol.

Some user interface considerations relating to configurations, features and parameters of data sonification operations are described in the aforementioned U.S. patent application Ser. No. 12/817,196. Beyond these, and more generally, configurations, features and parameters of data sonification operations can be selected via user interface dialog windows. General forms configuration-specification, feature-selection, and parameter-setting GUIs are known in the art.

### Uniform Parameterizations of Cell and Data Presentation Attributes

The invention provides for visualization rendering parameters to be uniform over a common variational range. This permits uniform handling of visualization rendering parameters and numerical operation compositions. Any of these can be set, varied, or modulated as selected or as advantageous to represent data or information derived from data. The invention provides for visualization rendering uniform parameters in the range of [0,1]. The uniform parameter range of [0,1] is used in the examples below, but it is understood that other choices for the uniform range are also possible and are provided for by the invention.

Color Morphing

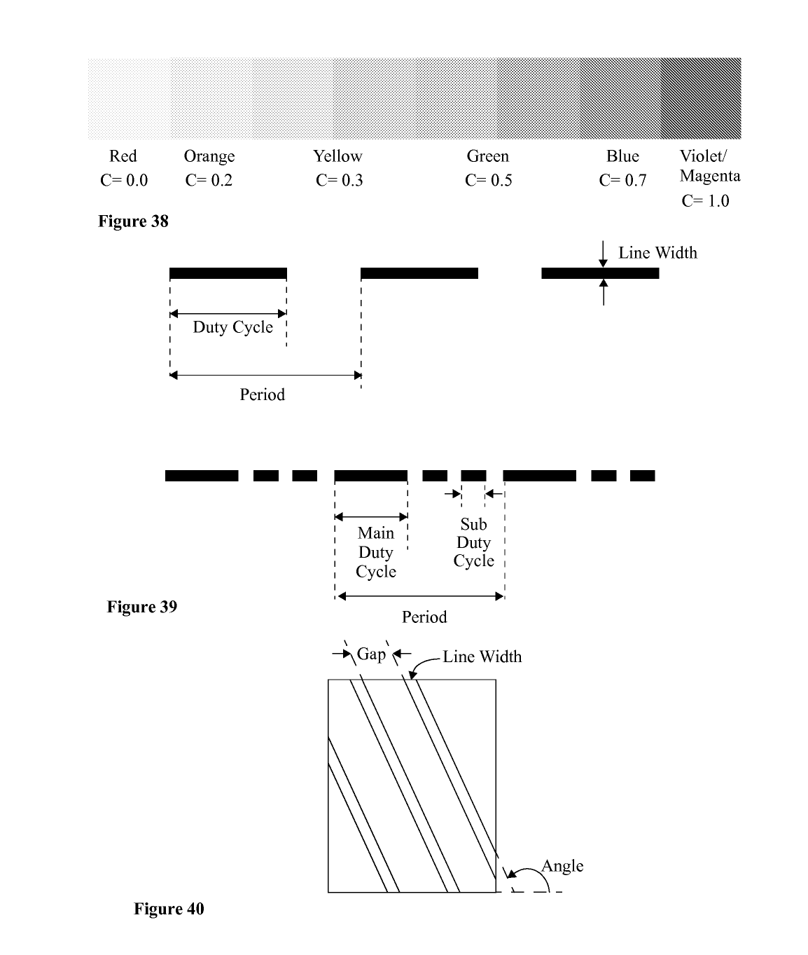

The invention provides for at least one color selection option to be determined by a uniform parameter in the range of [0,1]. FIG. 38 depicts the hue of a color can be varied through natural colors of red through violet for the bulk of the [0,1] range and a range of artificial colors, such as the purple through magenta continuum, are appended for the remaining portion of the [0,1] range. The invention also provides for other color models, such as RGB, HSB, LUV, LAB, grayscale, etc. to be used with one to three uniform parameters, each in the range of [0,1]. Such uniform parameter colors can be assigned one or more of text, symbols, borders, backgrounds, gridlines, glyphs, lines, components of lines, components of stipples, components of gradients, surfaces, and other geometric primitives employed in the visualization of data. Other variations and alternative arrangements are possible as is clear to one skilled in the art.

A uniform parameter range of [0,1] is used in the examples above, but it is understood that other choices for the uniform range are also possible and are provided for by the invention.

Line Morphing

The invention provides for at least one line rendering option to be determined by a uniform parameter in the range of [0,1]. FIG. 39 illustrates an example wherein line width is determined by a uniform parameter in the range of [0,1]. FIG. 39 also illustrates an example wherein line dashing period is determined by a uniform parameter in the range of [0,1]. FIG. 39 further illustrates an example wherein line dashing duty-cycle is determined by a uniform parameter in the range of [0,1]. FIG. 39 also illustrates an example wherein line dashing sub-duty-cycle is determined by a uniform parameter in the range of [0,1]. Other variations and alternative arrangements are possible as is clear to one skilled in the art.

The invention provides for line color to be determined by a uniform parameter color model as described above and for line dashing to include a plurality of colors.

Stipple Morphing

The invention provides for at least stipple pattern rendering option to be determined by a uniform parameter in the range of [0,1]. FIG. 40 illustrates an example wherein stipple line width is determined by a uniform parameter in the range of [0,1]. FIG. 40 also illustrates an example wherein stipple gap is determined by a uniform parameter in the range of [0,1]. A period and duty cycle model can be used instead and controlled via respectively associated uniform parameters varying over the range of [0,1].

FIG. 40 further illustrates an example wherein stipple angle is determined by a uniform parameter in the range of [0,1]. Other variations and alternative arrangements are possible as is clear to one skilled in the art.

The invention provides for at least one of stipple foreground and background colors to be determined by a uniform parameter color model as described above. The invention provides for a stipple pattern to comprise more than two colors, for the inclusion of line dashing in a stipple pattern, and for line dashing to include a plurality of colors.

Other variations and alternative arrangements are possible as is clear to one skilled in the art. A uniform parameter range of [0,1] is used in the examples above, but it is understood that other choices for the uniform range are also possible and are provided for by the invention.

Example User Interfaces for Adjusting Visualization Effect Attributes

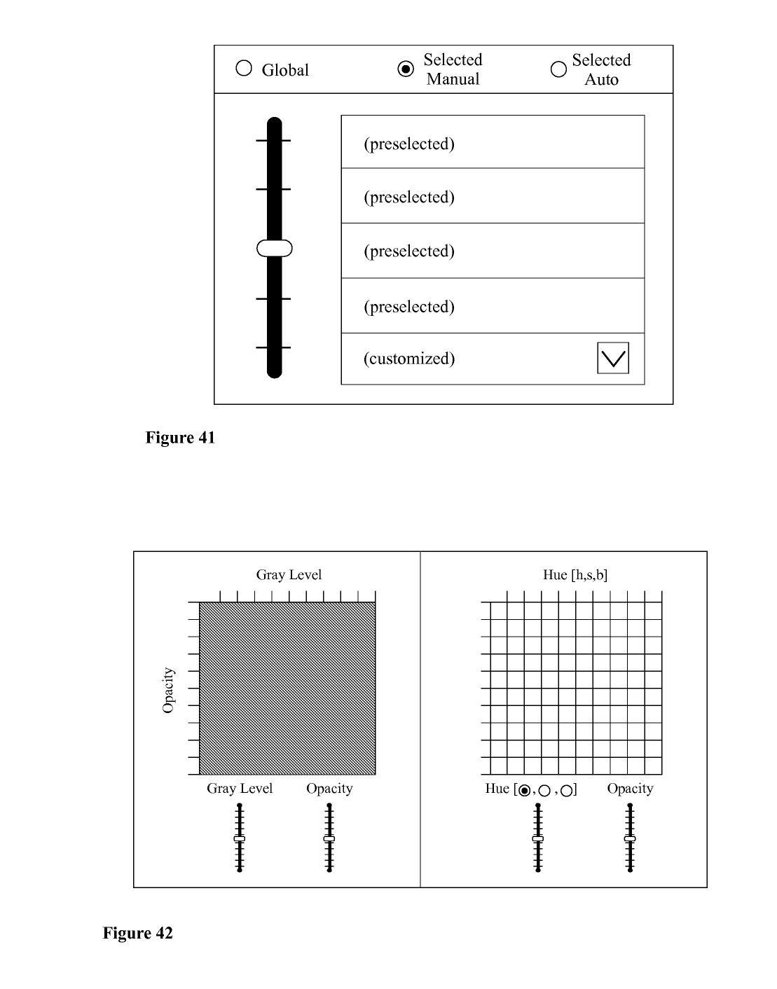

The invention provides for user interfaces to simplify operation with a friendly user interface for new or occasional users. A typical attribute control panel, as shown in FIG. 41, contains a few pre-selected values and a value which can be customized usually by selecting a value from a drop-down list.

FIG. 42 illustrates an interface for adjusting the color of a font can be specified for a cell, a group of cells, or globally across an entire worksheet. Users can select the color of a font simply by clicking on a region in the gray level or Hue color chart or by moving the slider that determines the gray level or parameters in Hue. A formula that determines such value can also be included. For example, the ratio of the data in a cell to the range of the data in a category can determine the value of gray level accordingly.

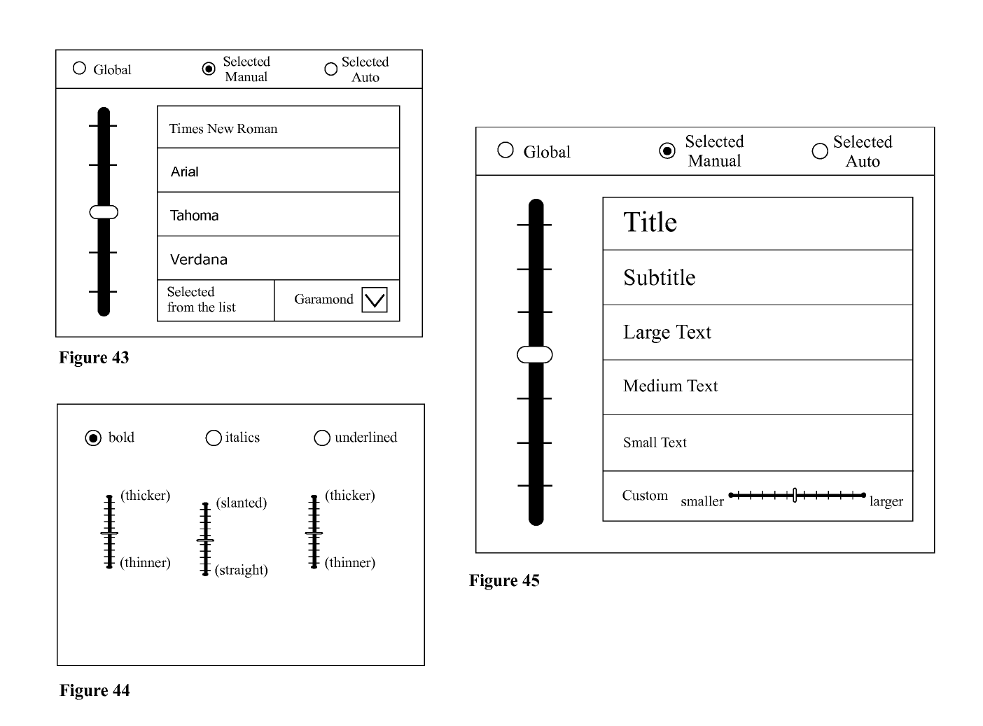

FIG. 43 depicts an interface for determining a font type of displayed text. Such interface can have a pre-selected list or a list to be customized or a combination of both, and can be implemented in a wide variety of ways. FIG. 44 depicts an example of an interface for determining the embellishment of a font rendered in a visualization. The percentage of bolding or the thickness of the underline can be varied. FIG. 45 depicts an example interface to control the size of a font to be displayed. Several preset sizes are listed on the panel as well as a slider that enables users to control the font size gradually. The interface provides for font size can be incremental with step sizes or nearly-continuous, and for the size to be adjusted by controlling a slider, as long as the value is positive and less than reasonable size compared to the area of the text displayed. Configurations, features and parameters for related operations, such as data set selection, data ranges, offsets, scalings, warping functions, etc., can be, for example, selected via traditional types of user interface dialog windows. General forms configuration-specification, feature-selection, and parameter-setting GUIs are known in the art.

Different formatting options can be applied to different types of data. The factor that determines the type of data can be obtained from the result of a hidden formula, from associated data such as the data from another column in the same row, or simply selected by the user. The number of decimals can be determined according to such factors. Also symbols can be attached according to the type of data. If the data in a cell represents currency, a currency symbol can be attached, and if the data represents percentage, a percentage sign will be attached. Further if the country is specified in another column, the corresponding country's currency sign can be attached.

The invention provides for the varying the color and opacity/transparency of the background color of a cell or group of cells as a function of data values. Specifying background color and opacity/transparency can be done similarly with the case for color of the font is determined, as illustrated in FIG. 42. For example, a user can affect the control the background color and opacity/transparency with the sliders or by simply clicking on a region of color or grayscale chart. The background color control can also be incorporate auto-scaling. Optionally, and the color can be determined depending on the ratio of the value of the cell to the values in the column. Configurations, features and parameters for related operations, such as data set selection, data ranges, offsets, scalings, warping functions, etc., can be, for example, selected via traditional types of user interface dialog windows. General forms configuration-specification, feature-selection, and parameter-setting GUIs are known in the art.

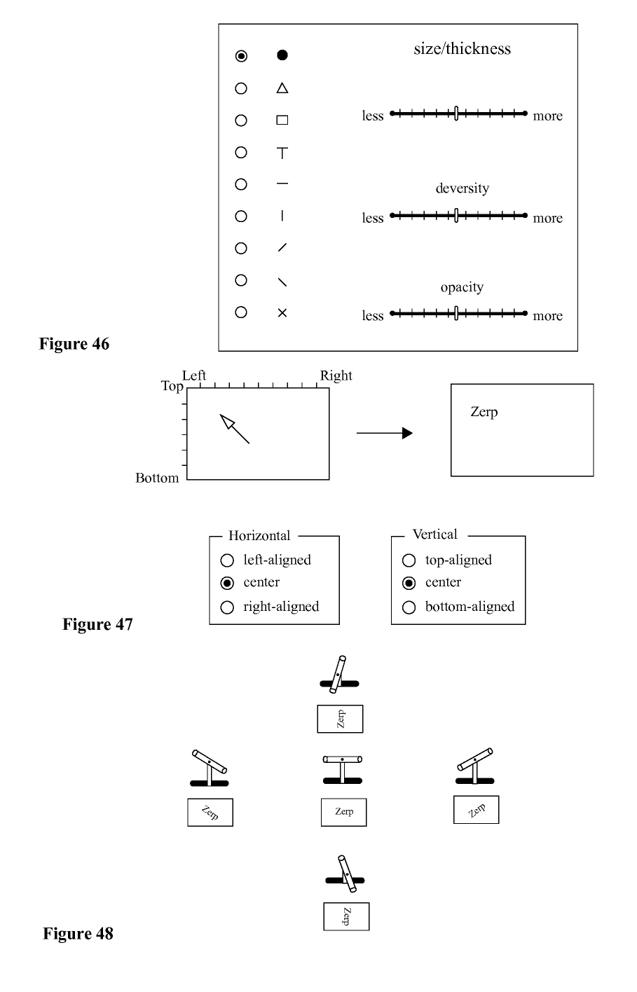

Similarly, the invention provides for the background texture or stipples as a function of data values. FIG. 46 depicts an interface that can be used to specify the background texture or stipples. The stipples can be made up of dots, shapes, or grid lines. The size, thickness, density, or opacity of the background can be adjusted with sliders as well. Stipples can be used alone or in combination with the background color. Configurations, features and parameters for related operations, such as data set selection, data ranges, offsets, scalings, warping functions, etc., can be, for example, selected via traditional types of user interface dialog windows. General forms configuration-specification, feature-selection, and parameter-setting GUIs are known in the art.

The invention provides for the specifying the location of a displayed data element within a cell. FIG. 47 depicts an interface that can be used to specify the fine-positioning of text being displayed in general or structured location. Users can move sliders by clicking and dragging on the icon and moving it vertically or horizontally to specify vertical or horizontal position of text displayed in a cell. Users can specify the point of vertical and horizontal centering by clicking on a region in the provided box and selecting how texts are aligned horizontally or vertically relative to the point specified. Values representing the left-right or up-down ratio can be simply entered in text boxes by the users. Configurations, features and parameters for related operations, such as data set selection, data ranges, offsets, scalings, warping functions, etc., can be, for example, selected via traditional types of user interface dialog windows. General forms configuration-specification, feature-selection, and parameter-setting GUIs are known in the art.

The invention provides for the specifying the location of a displayed rotation of text, symbols, or other information. FIG. 48 depicts an interface that can be used to specify the rotation of text, symbols, or other information displayed combined with the vertical or horizontal placement of the text. By clicking and dragging the right tip of the slider handle, the user can control the text to be rotated counter-clockwise, and vice versa. Vertical or horizontal shift of the position of the text can be controlled by clicking and dragging the middle of the slider handle to the desired direction. Configurations, features and parameters for related operations, such as data set selection, data ranges, offsets, scalings, warping functions, etc., can be, for example, selected via traditional types of user interface dialog windows. General forms configuration-specification, feature-selection, and parameter-setting GUIs are known in the art.

### Map Graphics

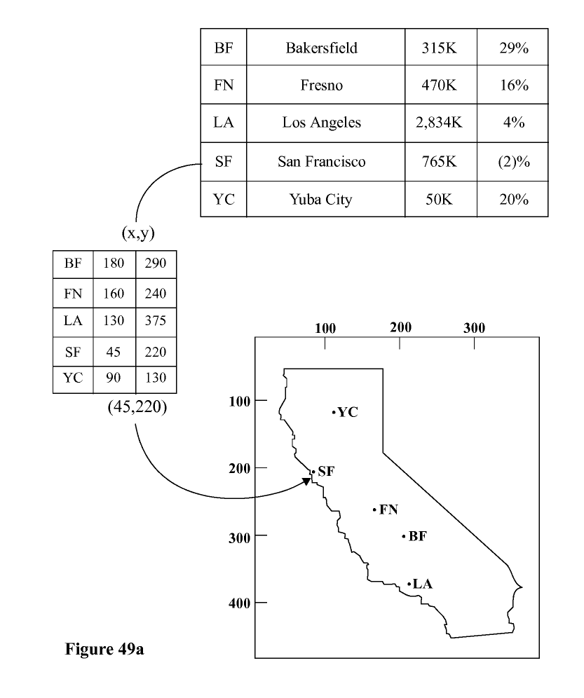

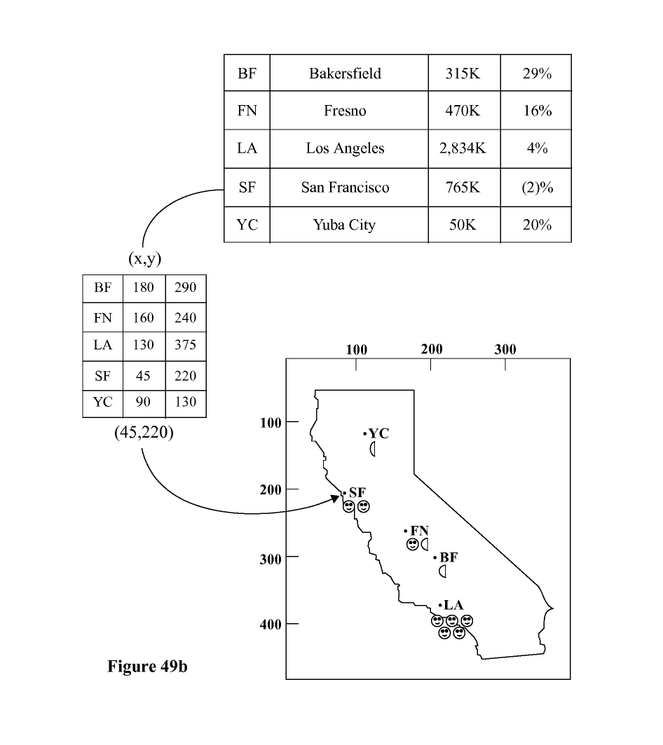

In another aspect of the invention function or mapping utilities can be included in the program. FIG. 49a illustrates a basic map-based visualization example generated from previous data. FIG. 49b illustrates the visualization of FIG. 49a augmented with additional spatially located symbols or parameterized glyphs. Configurations, features and parameters for related operations, such as data set selection, data ranges, offsets, scalings, warping functions, etc., can be, for example, selected via traditional types of user interface dialog windows. General forms configuration-specification, feature-selection, and parameter-setting GUIs are known in the art.

### 3D Manipulation Operations in Terms of Visualized Data

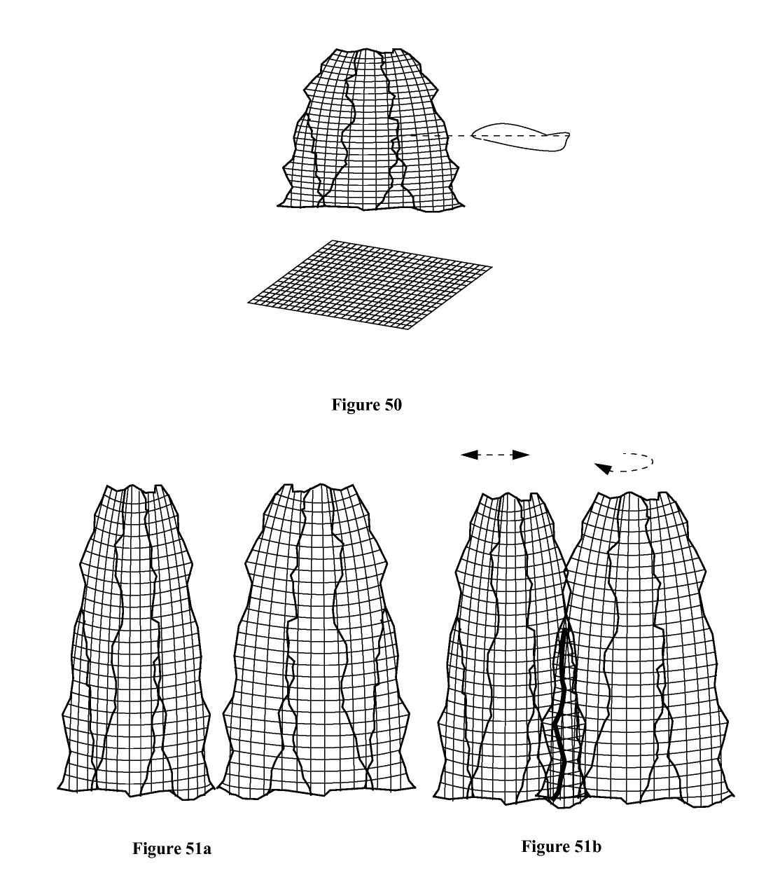

The invention provides for a slicing function to provide level set data. FIG. 50 depicts a slicing function, here used to provide a (planar-slice) level set curve. Other uses, implementations, and applications for slicing functions are also possible.

The invention provides for a more general surface intersection tool that can be used as a numerical solution operator for plotted, interpolated, and processed data. FIG. 51a illustrates two 2D-surfaces, each representing at least 3-dimensional data. Each of these can be interactively moved and rotated as described earlier. FIG. 51b illustrates the interactively created intersection of the two 2D-surfaces and the resultant intersection curve. A 2D-surface intersection tool allows the numerical values of selected points on a curve formed by the intersecting surfaces to be numerically calculated and visually displayed. The numerical values can also be used for other purposes and other subsequent calculations.

The sample points can be selected according to the details of the intersection. An adaptive sampling method can be employed. The resultant intersection data can be interpolated and re-sampled according to another sampling strategy. More than two surfaces can be intersected simultaneously, and various pair wise and group intersection data can be captured and displayed.

A second set of the useful novel 3D graphics visualization functions provided for by the invention pertain to multidimensional data visualizations based on 1D-curves embedded in a 3D visual field.

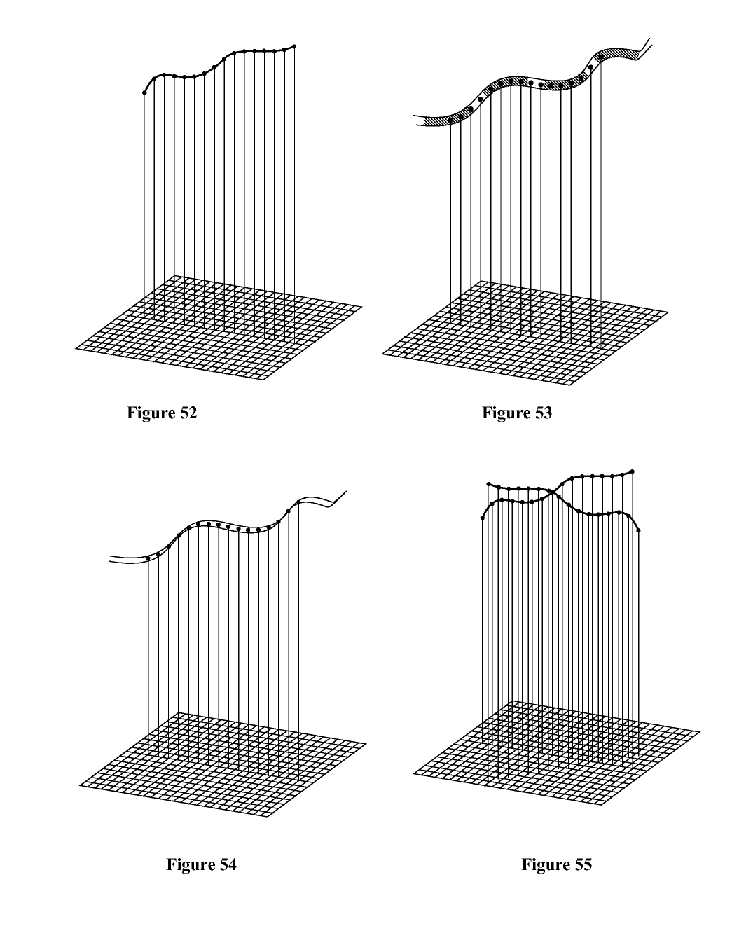

The invention provides for a curve to be generated by tabular data and to be suspended over tabular data used to create it or otherwise associated with the curve. The invention provides for the curve to be visually linked to a geometric rendering of tabular data. These features are illustrated by FIG. 52. The invention provides for the curve to be given a thickness and or color under the control of one or more data values. The invention provides for the color of the curve to be varied as a function of tabular (or other) data values. These features are illustrated by FIG. 53. The invention provides for the thickness of the curve to be varied as a function of tabular (or other) data values. This feature is illustrated in FIG. 54.

Such curve plotting utilities can be provided with functions, features, and operations like that of the 2D-surface utilities described above. The invention also provides for interactively shifting the observation point with respect to these objects for more detailed feature, theme, or trend inspection. The viewpoint can be changed according to the 6 degrees of freedom (three translations, three angles) of rigid motion. The viewpoint is changed under the control of an HDTP or an advanced mouse. The invention also provides for moving a curve within the 3D visual field. The curve can be moved according to the 6 degrees of freedom (three translations, three angles) of rigid motion. The 2D-surface can be moved under the control of an HDTP or an advanced mouse.

A curve of any thickness can be treated as if it comprises a surface that can be virtually illuminated by one or more lighting sources. The one or more lighting sources can be moved according to the 6 degrees of freedom (three translations, three angles) of rigid motion. The one or more lighting sources can also permit control of the color and intensity of virtual light emitted. A lighting source can be moved and controlled under the control of an HDTP or an advanced mouse.

The data plotted in a curve can directly echo the data displayed in the planar array of associated tabular data or spreadsheet, or can originate from another set of tabular data or spreadsheet region, or can originate from other data. The invention also provides for processing of the data via mathematical transformations, statistical processing, signal processing, etc. prior to creation of the curve. A curve can plot filtered or averaged versions of tabular data, spreadsheet data, or other data. The filtering or averaging can be controlled by an interactive parameter.

The invention provides for a curve to be rendered along with a height measuring visual, and also provides for a locally variable parameterized texture to be imposed on the curve and for the texture to be varied as a function of tabular or other data.

The invention provides for the curve to be rendered with numerical values displayed adjacently at specific points on the curve and that these can be used to represent an additional dimension of data. The invention also provides for the curve to be rendered with symbols displayed adjacently at specific points on the curve and that these can be used to represent an additional dimension of data. The invention further provides for the curve to be rendered with parameterized glyphs displayed adjacently at specific points on the curve and that these can be used to represent (an) additional dimension(s) of data.

The invention provides for a curve intersection tool that can be used as a numerical solution operator for plotted, interpolated, and processed data. FIG. 63 illustrates two curves, each representing at least 2-dimensional data. Each of these can be interactively moved and rotated as described earlier, interactively creating an intersection of the two curves and at least one resultant intersection point. A 2D-surface intersection tool allows the numerical values of intersection points to be numerically calculated and visually signified. The numerical values can also be used for other purposes and other subsequent calculations.

More than two curves can be intersected simultaneously, and various pair-wise and group intersection data can be captured and displayed.

For example, a curve and a surface can be intersected simultaneously, and intersection data can be captured and displayed. As another example, more than two curves and at least one surface can be intersected simultaneously, and various pair-wise and group intersection data can be captured and displayed.

### Example Embodiment

In an embodiment, the invention provides a method for interactive data visualization to perform data analysis comprised dataflow processing of information and interactive data visualization, the method comprising:
Specifying a data source to provide data to be analysis;
Specifying a plurality of mathematical operations to be performed on the data to be provided by the data source, wherein:
   each of the plurality of mathematical operations designed to accept, operate on, and produce numerical data within the universal range of numbers; and
   at least one of the mathematical operations comprises a mathematical function that can be numerically calculated;
Specifying an interconnection among the plurality of mathematical operations so as to determine paths of dataflow among the plurality of mathematical operations;
Specifying at least one initial value of a function parameter to at least one of the plurality of mathematical operations, the mathematical operation responsive to the value of the function parameter;
Obtaining at least one collection of data from the data source, the collection of data comprising at least an array of data values;
Using at least one of the plurality of mathematical operations to compute at least one visual parameter responsive to at least one data value from the collection of data and responsive to the function parameter, wherein each visual parameter is a number within the universal range of numbers, and wherein said number is determined according to a numerically calculated mathematical function;
Controlling a visual effect of the at least one data value according to the at least one visual parameter;
Creating responsively-generated computer graphics instructions;
Rendering the visual effect from the computer graphics instructions to produce computer-produced graphical output representing at least one aspect of the collection of data.

While the invention has been described in detail with reference to disclosed embodiments, various modifications within the scope of the invention will be apparent to those of ordinary skill in this technological field. It is to be appreciated that features described with respect to one embodiment typically can be applied to other embodiments.

The invention can be embodied in other specific forms without departing from the spirit or essential characteristics thereof. The present embodiments are therefore to be considered in all respects as illustrative and not restrictive, the scope of the invention being indicated by the appended claims rather than by the foregoing description, and all changes which come within the meaning and range of equivalency of the claims are therefore intended to be embraced therein. Therefore, the invention properly is to be construed with reference to the claims.

I claim:

1. A method for interactive data visualization to perform data analysis the method comprising:
specifying a data source to provide data for analysis;
specifying a plurality of mathematical operations to be performed on the specified data, wherein each of the plurality of mathematical operations calculates resultant numerical data within a specified range of numbers;
specifying an interconnection network determining dataflow paths among the plurality of mathematical operations;
specifying at least one initial function parameter to at least one of the plurality of mathematical operations to calculate resultant numerical data from the specified data;
obtaining data from the data source;
computing the resultant numerical data responsive to the at least one initial function parameter and the specified, wherein the resultant numerical data is at least one visual parameter;
creating computer graphics instructions responsive to the at least one visual parameter; and
rendering the selected data and displaying the selected data on a computer display according to the at least one visual parameter.

2. The method of claim 1 wherein the computer graphics instructions are rendered as graphics in a browser.

3. The method of claim 1 wherein the computer graphics instructions are transmitted over a network.

4. The method of claim 1 wherein the at least one initial function parameter is changed by the user using an interface device.

5. The method of claim 4 wherein a display of the selected data changes responsive to the change in the at least one initial function parameter.

6. The method of claim 4 wherein changes to the at least one initial function parameter are transmitted over a network.

7. The method of claim 4 wherein changes to the at least one initial function parameter are provided by any one of a plurality of computing devices, each computing device operated by an associated user, each computing device having received the computer graphics instructions.

8. The method of claim 7 wherein the computer graphics instructions are transmitted over a network.

9. The method of claim 1 wherein specifying the interconnection network is accomplished by selecting function blocks using a palette of function blocks and by connecting function blocks using a drawing tool.

10. The method of claim 9 wherein selecting on each function block causes at least one dialog windows to appear for setting parameters associated with the function block.
